(19) United States
(12) Patent Application Publication
(10) Pub. No.: US 2025/0370460 A1
(43) Pub. Date: Dec. 4, 2025

(54) METHOD FOR GENERATING MOBLE OBJECT CONTROL INFORMATION, DEVICE FOR GENERATING MOBILE OBJECT CONTROL INFORMATION, MOBILE OBJECT, AND MOBILE OBJECT CONTROL SYSTEM

(71) Applicant: SONY GROUP CORPORATION, TOKYO (JP)

(72) Inventor: YUKI KATSUMATA, TOKYO (JP)

(21) Appl. No.: 18/876,458

(22) PCT Filed: May 24, 2023
(86) PCT No.: PCT/JP2023/019362

§ 371 Date: Dec. 18, 2024

(30) Foreign Application Priority Data
Jun. 28, 2022 (JP) 2022-103303

(51) Int. Cl. G05D 1/246; G05D 1/224; G05D 1/644; G05D 105/10; G05D 105/20; G05D 107/10; G05D 107/40; G05D 109/10; G05D 111/10

(52) U.S. Cl. CPC G05D 1/2467; G05D 1/2246; G05D 1/644; G05D 2105/10; G05D 2105/20; G05D 2107/10; G05D 2107/40; G05D 2109/10; G05D 2111/10

(57) ABSTRACT

To control a mobile object such as a robot by using data including a map in which class attributes for classes corresponding to rooms are recorded. Feature information about a class or mobile object control information about the class is recorded as class attributes in association with the class serving as segmented areas in a map of the traveling area of the mobile object such as a robot, for example, a semantic map. The map is a map that allows identification of a room type and the border between rooms, and the presence or absence of a person in a room or information indicating whether the entry of the robot is allowed is recorded as class attributes for the classes corresponding to each room. Travel control for the robot is performed using a map or data in which the class attributes are recorded.

### TECHNICAL FIELD

The present disclosure relates to a method for generating mobile object control information, a device for generating mobile object control information, a mobile object, and a mobile object control system. More specifically, the present disclosure relates to a method for generating mobile object control information, a device for generating mobile object control information, a mobile object, and a mobile object control system, in which control information is generated for mobile object control of a mobile object, e.g., an autonomous mobile object robot.

### BACKGROUND ART

Autonomous mobile object robots have been recently used in various fields. For example, robot cleaners are used indoors while delivery robots and the like are used outdoors.

Such an autonomous mobile object robot with a sensor for analyzing an ambient environment analyzes sensor detection information and moves while avoiding collision or contact with an obstacle.

Moreover, such an autonomous mobile object robot may move using a map created on the basis of sensor detection information or map information input from the outside.

For example, as a method for limiting a robot movement-enabled area, a guide tape or marker may be attached to a robot traveling area to distinguish between a travel-enabled area and a restricted area.

For example, PTL 1 (JP 2010-176203A) discloses a configuration in which marks are placed in a robot operating environment and a robot detects the marks to identify a movement-enabled area.

Unfortunately, the configuration of PTL 1 requires the process of placing marks in advance in a robot traveling area.

### CITATION LIST

### Patent Literature

[PTL 1]

JP 2010-176203A

### SUMMARY

### Technical Problem

For example, the present disclosure has been devised in view of the problem. An object of the present disclosure is to provide a method for generating mobile object control information, a device for generating mobile object control information, a mobile object, and a mobile object control system, in which mobile object control information for controlling the travel of a robot is generated by setting various attributes for various areas and objects in a moving environment of the robot without the process of placing marks.

In an example of the present disclosure, for example, a user sets attribute information about a restricted area and a movement-enabled area in a semantic map in which the border of a room in a robot traveling area can be identified, and the user controls a robot by using, as mobile object control information, the semantic map including the recorded attribute information. This processing achieves flexible robot travel control according to a user request.

### Solution to Problem

A first aspect of the present disclosure is
a mobile object control information generation method executed in a mobile object control information generation device,
the method including:
generating, by a data processing unit, mobile object control information in which feature information about a class or mobile object control information about the class is recorded as class attributes in association with the class serving as segmented areas in the map of the traveling area of a mobile object.

Furthermore, a second aspect of the present disclosure is
a mobile object control information generation device including a mobile object control information generation unit that generates mobile object control information in which feature information about a class or mobile object control information about the class is recorded as class attributes in association with the classes serving as segmented areas in the map of the traveling area of a mobile object.

Moreover, a third aspect of the present disclosure is
a mobile object control information generation device including: a display unit that displays the map of the traveling area of a mobile object;
an input unit that inputs feature information about a class or mobile object control information about classes serving as segmented areas in the map; and
a mobile object control information generation unit that generates or updates mobile object control information in which the feature information about a class input through the input unit or the mobile object control information about the class is recorded as class attributes.

Furthermore, a fourth aspect of the present disclosure is
a mobile object that moves according to mobile object control information in which feature information about a class or mobile object control information about the class is recorded as class attributes in association with the class serving as segmented areas in the map of the traveling area of the mobile object.

Moreover, a fifth aspect of the present disclosure is
a mobile object control system including: a mobile object, a controller that transmits control information to the mobile object, and a map generation device that generates a map of the traveling area of the mobile object,
wherein the map generation device
generates mobile object control information in which feature information about a class or mobile object control information about a class is recorded as class attributes in association with the class serving as segmented areas in the map of the traveling area of a mobile object, and
the controller
generates an updated map by performing processing for adding class attributes based on a user input to the mobile object control information generated by the map generation device, and
performs travel control on the mobile object by using the generated updated map.

Furthermore, a sixth aspect of the present disclosure is
a mobile object control system including: a mobile object, and a controller that transmits control information to the mobile object,
wherein the controller
generates a map of the traveling area of the mobile object, generates mobile object control information in which feature information about a class or mobile object control information about classes is recorded as class attributes in association with the classes serving as segmented areas in the generated map, and performs travel control on the mobile object by using the generated mobile object control information.

Still other objects, features and advantages of the present disclosure will become apparent by more detailed description on the basis of the embodiments of the present disclosure and the accompanying drawings described below. In the present specification, the system is a logical set of configurations of a plurality of devices, and the devices having each configuration are not limited to those in the same housing.

### Advantageous Effects of Invention

The configuration of one example according to the present disclosure implements, for example, a configuration for controlling a mobile object such as a robot by using data including a map in which class attributes for classes corresponding to rooms are recorded.

Specifically, for example, feature information about a class or mobile object control information about classes is recorded as class attributes in association with classes serving as segmented areas in a map of the traveling area of a mobile object such as a robot, for example, a semantic map. The map is a map that allows identification of a room type and the border between rooms, and the presence or absence of a person in a room or information indicating whether the entry of the robot is allowed is recorded as class attributes for the classes corresponding to the rooms. Travel control for a robot is performed using a map or data in which the class attributes are recorded.

The present configuration implements, for example, a configuration for controlling a mobile object such as a robot by using data including a map in which class attributes for classes corresponding to rooms are recorded.

Note that the effects described in the present specification are merely exemplary and not limited, and may have additional effects.

### BRIEF DESCRIPTION OF DRAWINGS

FIG. 1 is an explanatory drawing showing an example of a traveling environment in which a robot travels as a mobile object of the present disclosure.

FIG. 2 shows a configuration example of a mobile object control system according to the present disclosure.

FIG. 3 is an explanatory drawing showing an example of a semantic map.

FIG. 4 is an explanatory drawing showing input processing of user instruction information to the semantic map.

FIG. 5 is a sequence diagram showing an example of a processing sequence using a mobile object control system according to the present disclosure.

FIG. 6 is a sequence diagram showing an example of the processing sequence using the mobile object control system according to the present disclosure.

FIG. 7 is an explanatory drawing showing an example of map information used for generating the semantic map.

FIG. 8 is an explanatory drawing showing an example of the map information used for generating the semantic map.

FIG. 9 is an explanatory drawing showing an example of the generation of the semantic map on the basis of an occupied-grid map.

FIG. 10 is an explanatory drawing showing the semantic map generated by a semantic map generation device and classification for the semantic map.

FIG. 11 is an explanatory drawing showing an example of the semantic map in which feature information corresponding to classes (room types) is recorded as class attributes.

FIG. 12 shows a flowchart for explaining a basic sequence example of semantic map generation processing.

FIG. 13 is an explanatory drawing showing an example of the semantic map in which class attributes are recorded.

FIG. 14 is an explanatory drawing showing a specific example of class attributes recorded in the semantic map.

FIG. 15 shows a flowchart for explaining a sequence example of semantic map generation processing.

FIG. 16 is an explanatory drawing showing a specific example of class attributes recorded in the semantic map.

FIG. 17 is an explanatory drawing showing an example of the semantic map in which class attributes are recorded.

FIG. 18 shows a flowchart for explaining a sequence example of semantic map generation processing.

FIG. 19 is an explanatory drawing showing a specific example of processing for additionally recording user-defined class attributes to the semantic map.

FIG. 20 is an explanatory drawing showing an example of the semantic map in which the user-defined class attributes are recorded.

FIG. 21 is an explanatory drawing showing a specific example of processing for additionally recording the user-defined class attributes to the semantic map.

FIG. 22 is an explanatory drawing showing an example of the semantic map in which the user-defined class attributes are recorded.

FIG. 23 shows a robot moving outdoors and a robot movement area.

FIG. 24 is an explanatory drawing showing an example of a semantic map corresponding to the robot movement area shown in FIG. 23.

FIG. 25 is an explanatory drawing showing a specific example of processing for additionally recording the user-defined class attributes to the semantic map.

FIG. 26 is an explanatory drawing showing an example of the semantic map in which the user-defined class attributes are recorded.

FIG. 27 is an explanatory drawing showing an example of robot control using the semantic map in which the user-defined class attributes are recorded.

FIG. 28 shows the robot moving outdoors and a robot movement area.

FIG. 29 is an explanatory drawing showing an example of the semantic map corresponding to the robot movement area shown in FIG. 28.

FIG. 30 is an explanatory drawing showing a specific example of processing for additionally recording the user-defined class attributes to the semantic map.

FIG. 31 is an explanatory drawing showing an example of the semantic map in which the user-defined class attributes are recorded.

FIG. 32 is an explanatory drawing showing an example of robot control using the semantic map in which the user-defined class attributes are recorded.

FIG. 33 is an explanatory drawing showing a specific example of the user-defined class attributes recorded in the semantic map.

FIG. 34 is an explanatory drawing showing an example of the semantic map in which the user-defined class attributes are recorded.

FIG. 35 is an explanatory drawing showing a configuration example of each of the robot, a controller, and the semantic map generation device.

FIG. 36 shows a configuration example of a mobile object control system according to the present disclosure.

FIG. 37 shows a configuration example of the mobile object control system according to the present disclosure.

FIG. 38 is an explanatory drawing showing a configuration example of each of the robot and the controller.

FIG. 39 is an explanatory drawing showing a configuration example of each of the robot, the controller, and the semantic map generation device according to the present disclosure.

### DESCRIPTION OF EMBODIMENTS

A method for generating mobile object control information, a device for generating mobile object control information, a mobile object, and a mobile object control system according to the present disclosure will be specifically described below with reference to the accompanying drawings. The description will be given in the following order.
1. Example of robot traveling environment and semantic map used for travel control
2. Example of processing sequence using mobile object control system according to present disclosure
3. Specific example of semantic map generation processing by semantic map generation device and specific example of generated semantic map
4. Sequence of semantic map generation processing by semantic map generation device
5. Specific example of semantic map updating processing through input processing of class-corresponding attribute information by user
5-1. (Example 1) Example in which robot operation-enabled area and operation- prohibited area for each class are recorded and used as user-defined class attributes for semantic map for robot moving indoors
5-2. (Example 2) Example in which unrestricted area and restricted area for each class are recorded and used as user-defined class attributes for semantic map for robot moving indoors
5-3. (Example 3) Example in which accessible area and inaccessible area for each class are recorded and used as user-defined class attributes for semantic map for robot moving outdoors
5-4. (Example 4) Example in which movement-enabled area and movement- prohibited area for each class are recorded and used as user-defined class attributes for semantic map for robot moving outdoors
5-5. (Example 5) Example in which time-corresponding class attributes are recorded and used as user-defined class attributes for semantic map for robot moving indoors
6. Configuration example of each device
7. Hardware configuration example of each device
8. Summary of configuration of present disclosure

### 1. Example of Robot Traveling Environment and Semantic Map Used for Travel Control

First, an example of a robot traveling environment and a semantic map used for travel control will be described below.

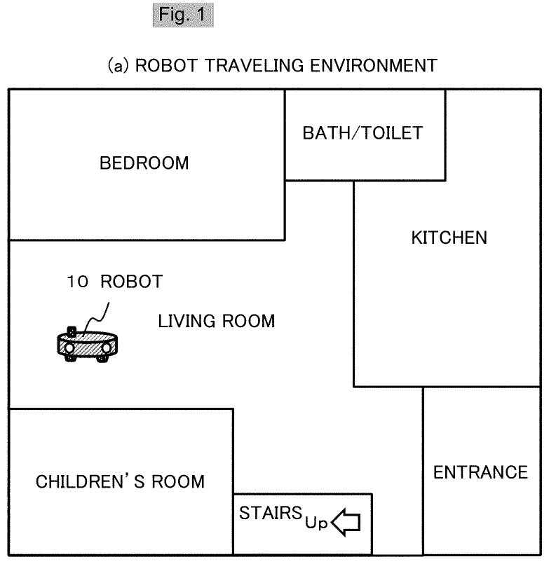

FIG. 1 illustrates an example of a traveling environment in which a robot 10 travels as a mobile object of the present disclosure.

FIG. 1 shows (a) an example of a floor of a house as an example of a robot traveling environment. The robot 10 moves through rooms on the floor of the house. The robot 10 is, for example, a mobile object “robot cleaner.” Alternatively, the robot 10 may be a robot that performs various tasks (processes) other than cleaning, for example, the process of moving through rooms of a house to carry goods.

For example, the robot 10 performs a task such as cleaning specified by, for example, the controller of a user.

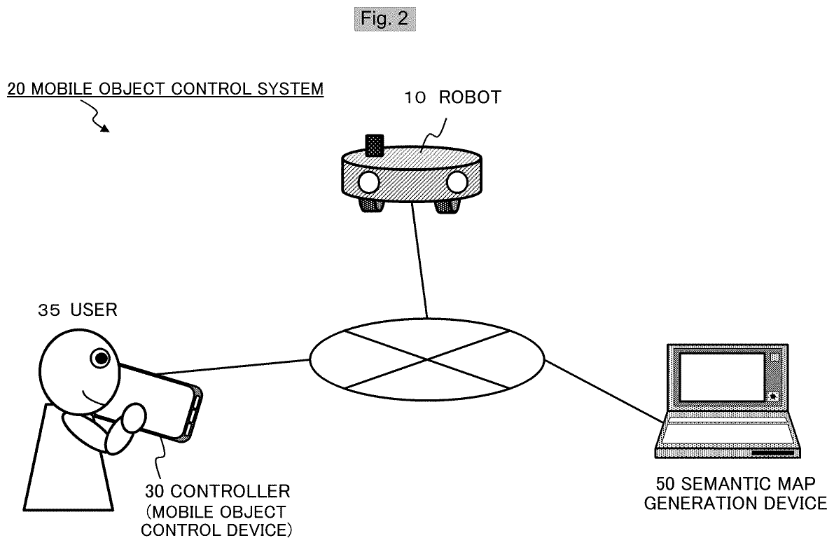

FIG. 2 illustrates a configuration example of a mobile object control system 20 according to the present disclosure.

The mobile object control system 20 in FIG. 2 includes the robot 10, a controller (mobile object control unit) 30, and a semantic map generation device 50.

These units are configured to communicate with one another.

Two of these units, that is, the controller (mobile object control unit) 30 and the semantic map generation device 50 both correspond to a mobile object control information generation device of the present disclosure.

The controller (mobile object control unit) 30 is operated by a user 35.

The robot 10 performs a process, e.g., cleaning according to a task input to the controller (mobile object control unit) 30 by the user 35.

The semantic map generation device 50 generates a semantic map of the traveling environment of the robot 10 as a process preparatory to the task of the robot 10. The semantic map is a map that allows identification of object types of various objects in the traveling environment of the robot 10. In the process of the present disclosure, a semantic map is generated to identify each room in the robot traveling environment described with reference to FIG. 1, that is, a semantic map is generated to identify the border between rooms and perform classification by room type.

The objects also include an object usable for identifying the traveling environment of the robot 10, that is, an object (an object characterized by the location) indicating a room type and location characteristics, in addition to an obstacle to the travel of the robot 10.

The object (an object characterized by the location) indicating a room type and location characteristics is, for example, an object described below.

For example, a frying pan is likely to be present in a kitchen and thus corresponds to an object characterized by the kitchen.

For example, a full-length mirror is likely to be present in a closet and thus corresponds to an object characterized by the closet.

The semantic map generation device 50 causes the robot 10 to travel, receives detection information of a sensor mounted on the robot 10, performs learning processing (machine learning) using the sensor detection information, and generates a semantic map that allows identification of the border between rooms and room types in the robot traveling environment.

The robot 10 is equipped with, for example, a camera or a sensor such as a LiDAR (Light Detection and Ranging), which is a sensor for measuring a distance to an obstacle with a laser beam.

The robot 10 transmits sensor detection information including images captured by a camera to the semantic map generation device 50. The semantic map generation device 50 performs learning processing (machine learning) using the sensor detection information input from the robot 10, and generates a semantic map that allows identification of the border between rooms and room types in the robot traveling environment.

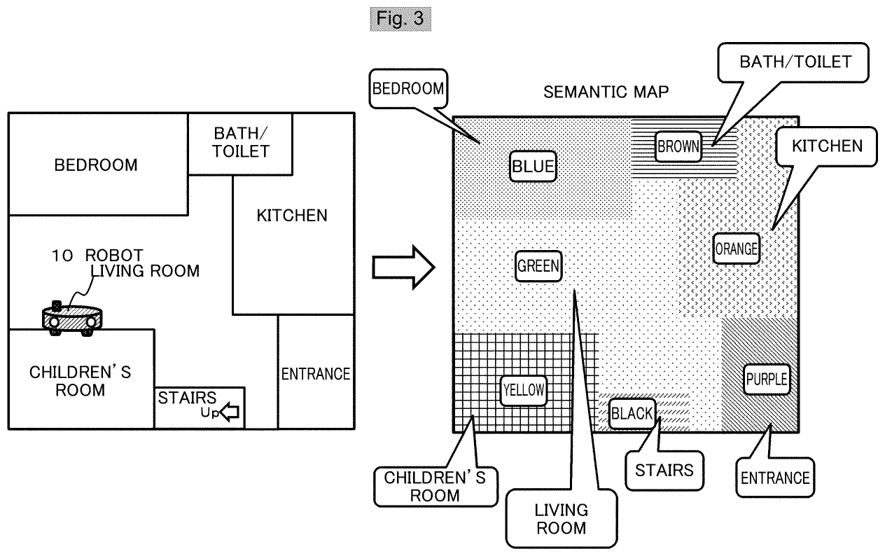

FIG. 3 shows an example of a semantic map. The semantic map is a map generated by semantic mapping.

Semantic mapping is the process of identifying the type of class to which each coordinate in the map of an environment managed by the robot 10 belongs.

For example, a class is set according to the type of identified object, and a color and an identifier are set according to the object type (=class).

This semantic mapping can be performed using, for example, a learning model that applies algorithms such as a deep neural network (DNN: Deap Neural Network), which is a multi-layered neural network, a convolutional neural network (CNN: Convolutional Neural Network), or a recurrent neural network (RNN: Recurrent Neural Network), and identifies an object corresponding to each pixel on the basis of, for example, a feature amount obtained from an image.

In the present example, the type (class) of an object identified by the robot 10 is, for example, a room type.

In the present example, the semantic map generation device 50 identifies a room in the traveling environment where the robot 10 travels, and generates a semantic map in which a class corresponding to the type of identified room is set. For example, a semantic map is generated such that a different color is set for each room type (class).

FIG. 3 shows an example of a semantic map generated by the semantic map generation device 50.

FIG. 3 shows an example of a semantic map in which different colors are set for room types as follows:
Living room=green
Bedroom=blue
Bath/toilet=brown
Kitchen=orange
Entrance=purple
Stairs=black
Children's room=yellow

The semantic map generation device 50 generates a semantic map in which classes (identifiers) corresponding to room types shown in FIG. 3 are set, and transmits the generated semantic map to the controller (mobile object control unit) 30 used by the user 35.

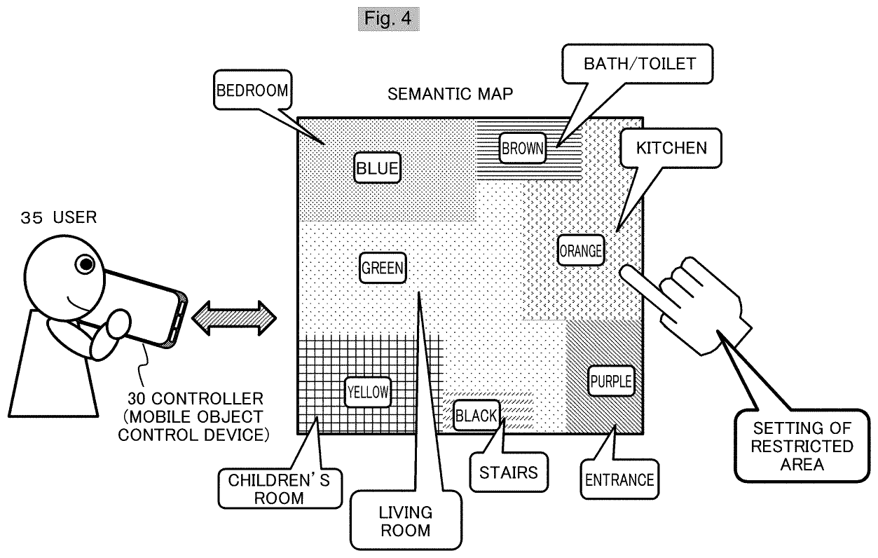

As shown in FIG. 4, the user 35 displays the semantic map received from the semantic map generation device 50 on the display unit of the controller (mobile object control unit) 30.

The user 35 confirms the semantic map displayed on the display unit of the controller (mobile object control unit) 30 and inputs a user instruction, for example, user instruction information about the setting of a specific room as a restricted area of the robot 10.

In response to the input of the user instruction information, the semantic map is updated.

Specifically, the user instruction information is additionally recorded in the semantic map as attribute information about the semantic map, so that an updated semantic map is generated with the additionally recorded user instruction information.

The controller 30 transmits a command for requesting the execution of a task (e.g., cleaning) to the robot 10 on the basis of the updated semantic map, for example, a semantic map in which the kitchen is set as a robot restricted area.

In response to the command, the robot 10 performs the task according to the updated semantic map.

In other words, on the basis of the semantic map in which the kitchen is set as a robot restricted area, a traveling route is set without including the kitchen.

As described above, in the processing of the present disclosure, the semantic map is updated by inputting various user instructions to the semantic map generated by the semantic map generation device 50, and the updated semantic map is used as robot control information.

This processing achieves robot control according to the intention of the user.

### 2. Example of Processing Sequence Using Mobile Object Control System According to Present Disclosure

An example of a processing sequence using the mobile object control system according to the present disclosure will be described below.

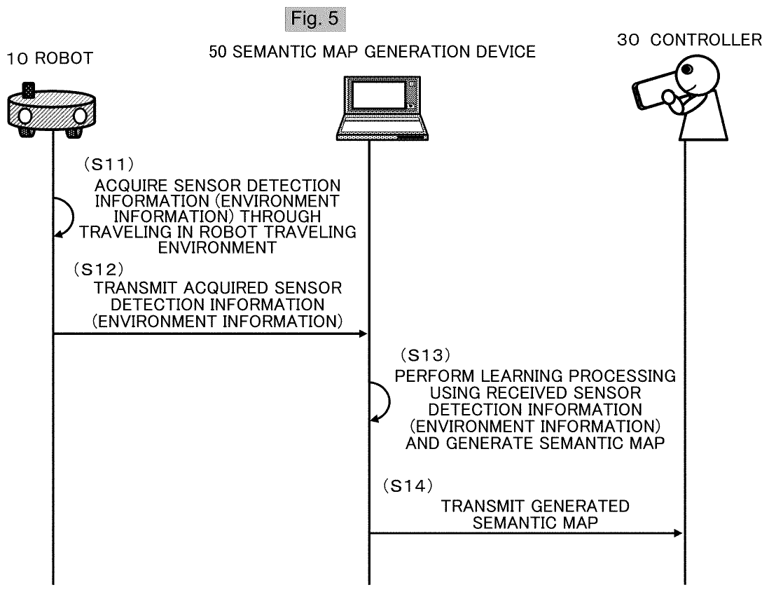

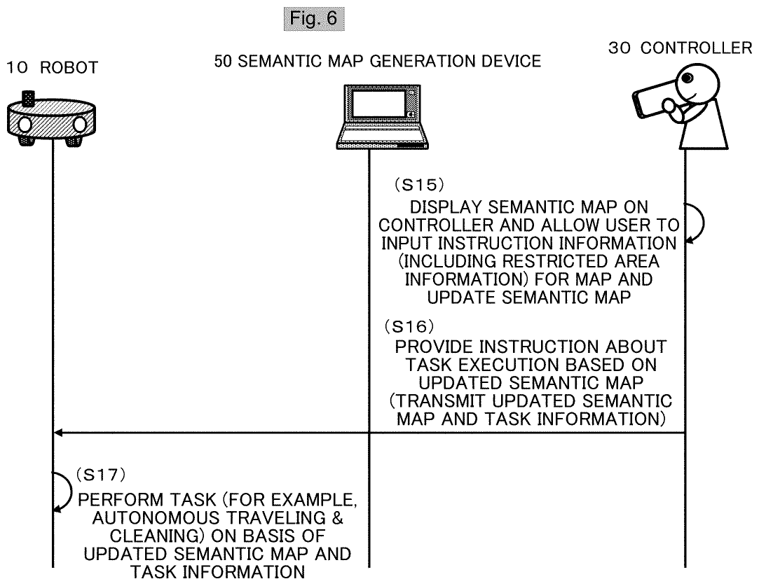

FIGS. 5 and 6 are sequence diagrams showing an example of a processing sequence using the mobile object control system according to the present disclosure.

The robot 10, the semantic map generation device 50, and the controller 30 are indicated from the left. The processing of each device and data transmission and reception between the devices are shown as time-series processing from step S11 to step S17.

Processing in the steps of the sequence diagrams in FIGS. 5 and 6 will be sequentially described below.

### (Step S11)

First, in step S11, the robot 10 travels in a robot traveling environment, for example, a traveling environment such as the floor of the house in FIG. 1 and acquires sensor detection information (environment information).

As described above, the robot 10 is equipped with a camera or a sensor such as a LiDAR (Light Detection and Ranging), which is a sensor for measuring a distance to an obstacle with a laser beam.

The sensor mounted on the robot 10 is not limited to a camera or a LiDAR. Other different types of sensors are also available. For example, usable sensors include an IMU (inertial measurement unit (Inertial Measurement Unit)) that detects the acceleration and the angular velocity or the like of a robot, an odometry device that detects, for example, the number of revolutions of a robot tire, an illuminance sensor for detecting the brightness of a room, a microphone that acquires voice information about surroundings, and a pressure sensor that acquires information for estimating the hardness, softness, and material or the like of a floor.

In step S11, the robot 10 acquires sensor detection information (environment information) through various sensors, in addition to images captured by the camera during the travel of the robot.

The sensor detection information (environment information) acquired by the traveling robot 10 is used as learning data for generating a semantic map in the semantic map generation device 50.

### (Step S12)

In step S12, the robot 10 transmits the sensor detection information (environment information) acquired in step S11 to the semantic map generation device 50.

The robot 10 sequentially transmits sensor detection information including images captured by the camera during the travel, to the semantic map generation device 50.

### (Step S13)

The semantic map generation device 50 performs learning processing using the sensor detection information (environment information) received from the robot 10 and generates a semantic map.

As described above, an object type is identified for each pixel to generate a semantic map, for example, by processing using learning algorithms such as a neural network (NN: Neural Network).

Moreover, an object type to be identified in the processing of the present disclosure is “room type” as described above.

In step S13, the semantic map generation device 50 performs learning processing using the sensor detection information (environment information) received from the robot 10, performs classification according to room types, and generates a semantic map that allows identification of the border between rooms and room types. The semantic map is generated as described with reference to FIGS. 3 and 4.

Furthermore, as learning methods used for generating a semantic map by the semantic map generation device 50, various methods such as supervised learning and unsupervised learning including self-supervised learning can be used. Moreover, a rule-based method may be used without machine learning in the configuration.

The semantic map generation device 50 further analyzes various features for each class (room type) set in the semantic map, on the basis of the sensor detection information of the robot 10, and records the analysis result as class attributes in the semantic map.

The detail of semantic map generation and the setting of class attributes by the semantic map generation device 50 and a specific example of a semantic map to be generated will be described later.

### (Step S14)

In step S14, the semantic map generation device 50 transmits the semantic map generated in step S13 to the controller 30 operated by the user 35.

### (Step S15)

In step S15, the user 35 displays the semantic map received from the semantic map generation device 50 on the display unit of the controller (mobile object control unit) 30.

The user 35 confirms the semantic map displayed on the display unit of the controller (mobile object control unit) 30 and inputs a user instruction, for example, user instruction information about the setting of a specific room as a restricted area of the robot 10.

The user instruction information is additionally recorded in the semantic map as attribute information (user setting class attributes) corresponding to the classes of the semantic map, and the semantic map is updated.

In other words, the user-defined class attributes generated on the basis of the user-specified information are additionally recorded in semantic map data as data constituting the semantic map.

A specific example of the processing in step S15, that is, updating of the semantic map by recording class attributes in the semantic map on the basis of the user instruction information will be specifically described later.

### (Step S16)

In step S16, the user 35 transmits a task execution command to the robot 10 on the basis of the semantic map updated in step S15, that is, the updated semantic map further including the user-defined class attributes based on the user instruction information.

When the task execution command is transmitted, the updated semantic map further including the user-defined class attributes and task information are transmitted to the robot 10.

The updated semantic map further including the user-defined class attributes is used as control information about the robot 10, that is, mobile object control information.

### (Step S17)

In step S17, the robot 10 receives the task execution command transmitted by the controller 30 and performs the task (e.g., cleaning) according to the received task execution command.

The task is performed with reference to the updated semantic map.

For example, when a certain class, e.g., “class=kitchen” as a user-defined class attribute of the updated semantic map is set as a restricted area, a task (e.g., cleaning) is performed after a traveling route is set without including the kitchen.

In this way, in the processing of the present disclosure, the robot is controlled according to the intention of the user by using, as mobile object control information, the class attributes based on the user instruction information, that is, the updated semantic map further including the user-defined class attributes.

### 3. Specific Example of Semantic Map Generation Processing by Semantic Map Generation Device and Specific Example of Generated Semantic Map

A specific example of semantic map generation processing by the semantic map generation device and a specific example of the generated semantic map will be described below.

In step S13 of the sequence diagram of FIG. 5, the semantic map generation device 50 performs learning processing using the sensor detection information (environment information) received from the robot 10 and generates the semantic map.

As described above, for example, by processing using learning algorithms such as a neural network (NN: Neural Network), an object type (room type) is identified for each pixel to generate the semantic map in which a class is set for the room type.

When the semantic map is generated, the semantic map generation device 50 can use map information about the generation area of the semantic map as basic information.

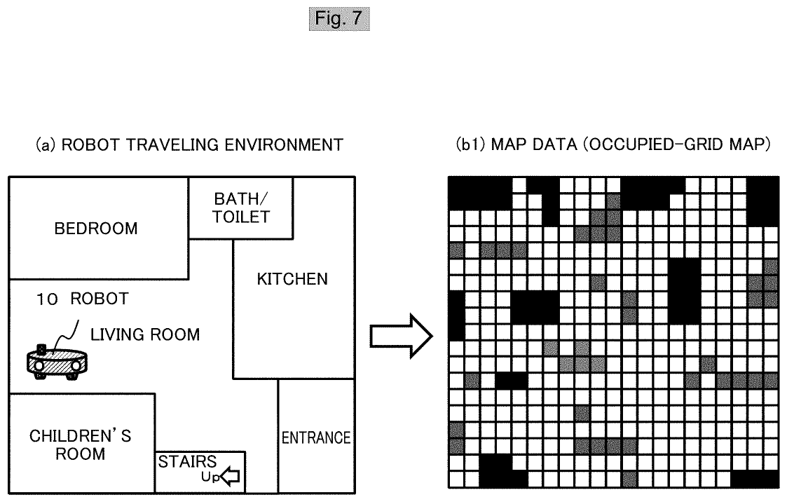

Referring to FIG. 7 and the subsequent drawings, an example of the map information used for generating the semantic map by the semantic map generation device 50 will be described below.

FIG. 7 shows (a) robot traveling environment described with reference to FIG. 1, and “(b1) occupied-grid map” as an example of map data of “(a) robot traveling environment.”

“(b1) occupied-grid map” is a map indicating the probability of an occupied obstacle for each rectangular area (grid) in the map. For example, a rectangular area (grid) with a high probability of an occupied obstacle is set to be black, an area with a low probability of an occupied obstacle is set to be white, and an intermediate area is set to be gray or the like.

The occupied-grid map can be generated using the sensor detection information of the robot 10 caused to travel in the robot traveling environment, the sensor detection information including, for example, images captured by the camera.

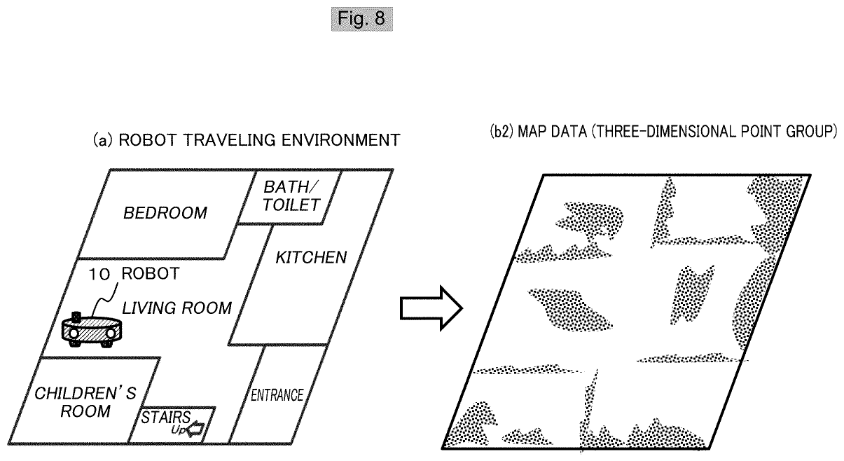

FIG. 8 shows “(b2) three-dimensional point group” as another example of map data of “(a) robot traveling environment.”

“(b2) three-dimensional point group” is a map in which a point group is indicated at the position of an obstacle. An obstacle is located at the position of a point in “(b2) three-dimensional point group” shown in FIG. 8.

The three-dimensional point group can also be generated using the sensor detection information of the robot 10 caused to travel in the robot traveling environment, the sensor detection information including, for example, images captured by the camera.

When the semantic map is generated, the semantic map generation device 50 can use, for example, “(b1) occupied-grid map” in FIG. 7 or “(b2) three-dimensional point group” as a base map. A map used as the base map of the semantic map is not limited to “(b1) occupied-grid map” or “(b2) three-dimensional point group,” and a two-dimensional map, a three-dimensional map, and a topological map in other various forms are also usable.

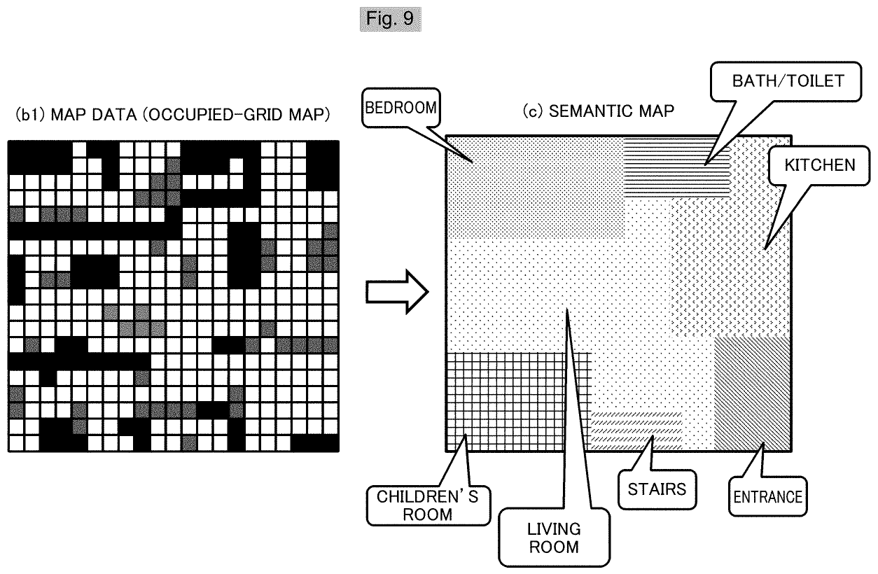

FIG. 9 shows an example of the generation of the semantic map on the basis of “(b1) occupied-grid map” in FIG. 7.

The semantic map generation device 50 determines, for example, the border between rooms by using, for example, information detected from “(b1) occupied-grid map” in FIG. 9 in addition to the analysis result of the sensor detection information of the robot 10. For example, a linear obstacle area or the like is recognized as a wall serving as the border between rooms, identifies the border between rooms, and determines the border of each room. Furthermore, as described above, the type of each room is determined on the basis of learning processing or the like using the sensor detection information of the robot 10, and a semantic map is generated with a class set for each room type.

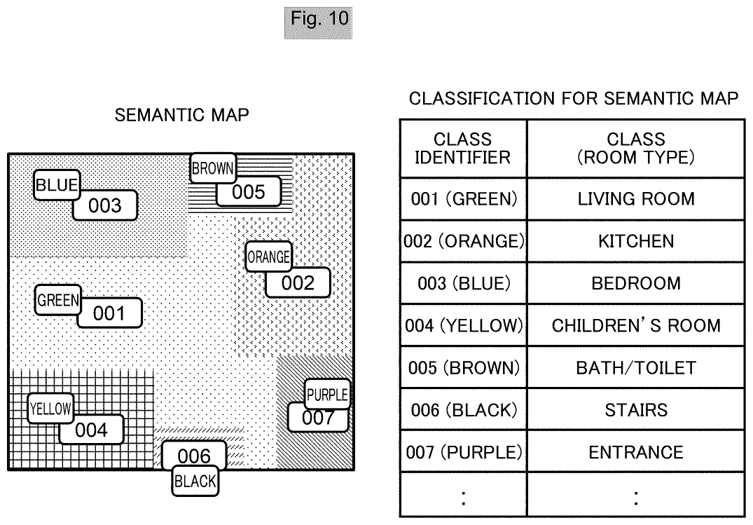

FIG. 10 shows an example of the semantic map generated by the semantic map generation device 50 and an example of classification for the semantic map.

As shown on the right side of FIG. 10, for example, the semantic map includes the following classes:
Class identifier 001 (green) class (room type)=living room
Class identifier 002 (orange) class (room type)=kitchen
Class identifier 003 (blue) class (room type)=bedroom
Class identifier 004 (yellow) class (room type)=children's room
Class identifier 005 (brown) class (room type)=bath/toilet
Class identifier 006 (black) class (room type)=stairs
Class identifier 007 (purple) class (room type)=entrance

In this way, the classes are set for the respective room types in the semantic map generated by the semantic map generation device 50.

Moreover, the semantic map generation device 50 of the present disclosure records feature information corresponding to classes (room types) set in the semantic map, that is, feature information corresponding to classes (room types) detected by the sensor of the robot 10, as attribute information (class attributes) in the semantic map.

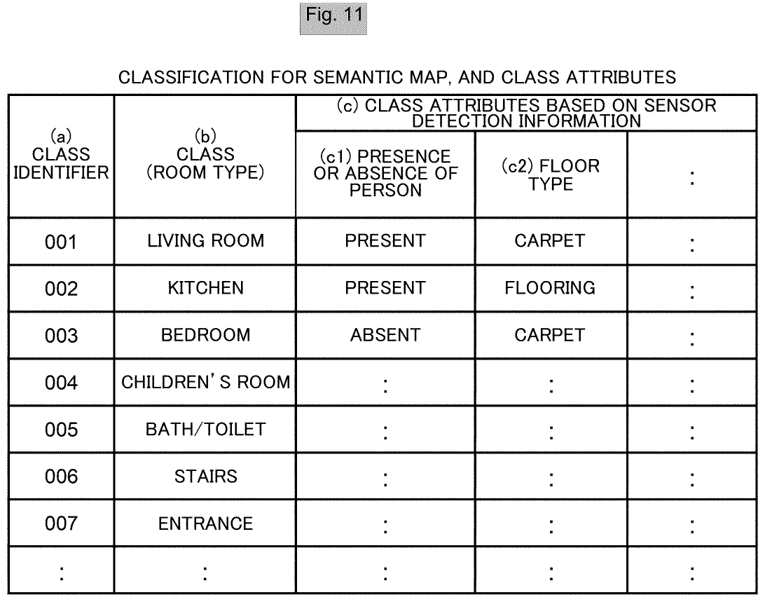

Referring to FIG. 11, an example of a semantic map, in which feature information corresponding to classes (room types) is recorded as class attributes, will be described below.

As described with reference to the sequence diagrams of FIGS. 5 and 6, in the semantic map generation processing of FIG. 5 (step S13), the semantic map generation device 50 analyzes various features for each class (room type) set in the semantic map, on the basis of the sensor detection information of the robot 10, and then the semantic map generation device 50 records the analysis result as class attributes in the semantic map.

In (step S15), the user 35 records the class attributes based on the user instruction information (user-defined class attributes) in the semantic map by using the controller 30.

FIG. 11 shows an example of data constituting the semantic map generated by the semantic map generation device 50 in (step S13) of FIG. 5.

In other words, the example shows data constituting the semantic map in which the semantic map generation device 50 analyzes various features for each class (room type) on the basis of the sensor detection information of the robot 10 and records the analysis result as class attributes.

In the data constituting the semantic map in FIG. 11, class attributes ((c) class attributes based on sensor detection information) are recorded. The class attributes are generated by the semantic map generation device 50 on the basis of the sensor detection information.

The data constituting the semantic map in FIG. 11 includes the following information:
(a) Class identifier
(b) Class (room type)
(c) Class attributes based on sensor detection information

Among the information of (a) to (c), “(c) class attributes based on sensor detection information” are class attributes that are generated and recorded by the semantic map generation device 50.

The semantic map generation device 50 analyzes features for classes (room types) on the basis of the sensor detection value of the robot 10, generates class attributes on the basis of analyzed feature information, and records the class attributes.

FIG. 11 shows specific examples of “(c) class attributes based on sensor detection information” as below.
(c1) Presence or absence of person
(c2) Floor type

For example, “(c1) presence or absence of person” is determined on the basis of images captured by the camera that is a sensor of the robot 10 or voice information acquired by a microphone.

Moreover, “(c2) floor type” is determined on the basis of information acquired by a pressure sensor that is a sensor of the robot 10 or traveling sound information acquired by the microphone when the robot travels.

As described above, the semantic map generation device 50 of the present disclosure analyzes the sensor detection value of the robot 10, acquires feature information corresponding classes (room types), and records the feature information as attribute information corresponding to the classes of the semantic map.

In the example of FIG. 11, as “(c) class attributes based on sensor detection information,” the following class attribute information is recorded.

For (c1) presence or absence of person,
Class (living room)=present
Class (kitchen)=present
Class (bedroom)=absent

Furthermore, for (c2) floor type, the following class attribute information is recorded.
Class (living room)=carpet
Class (kitchen)=flooring
Class (bedroom)=carpet

The class-corresponding attribute information of the semantic map is used for, for example, the execution of a task by the robot 10 and the determination of a traveling route. For example, when a task to be performed by the robot 10 is cleaning, the process of cleaning or the like can be performed first in a location where a person is absent while avoiding a location where a person is present. Moreover, the attribute information can also be used for speed control processing. For example, the speed of the traveling robot is changed according to the floor type to reduce noise.

### 4. Sequence of Semantic Map Generation Processing by Semantic Map Generation Device

A sequence of semantic map generation processing by the semantic map generation device will be described below.

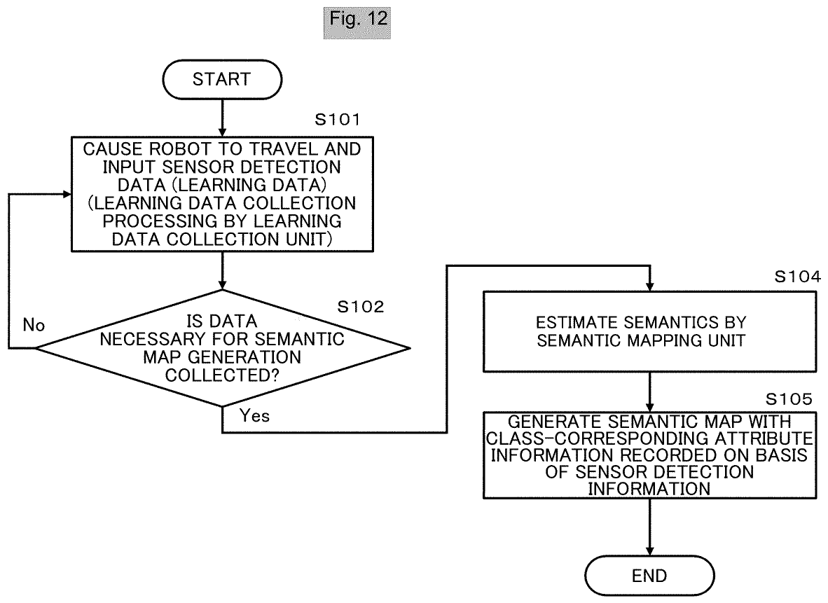

First, referring to the flowchart of FIG. 12, a basic sequence example of semantic map generation processing by the semantic map generation device 50 of the present disclosure will be described below.

Processing in the steps of the flow shown in FIG. 12 will be sequentially described below.

### (Step S101)

First, in step S101, the semantic map generation device 50 transmits a travel command to the robot 10, causes the robot 10 to travel, and receives sensor detection data (learning data), which is detected by a sensor such as a camera mounted on the robot 10, from the robot 10.

For example, the robot 10 is caused to travel through all the areas in the robot traveling environment shown in FIG. 1, and then sensor detection information detected at each position is input.

This process corresponds to the process of collecting learning data for generating a semantic map.

### (Step S102)

In step S102, the semantic map generation device 50 determines whether the sensor detection data (learning data) received from the robot 10 has reached the level where a semantic map can be generated.

For example, it is determined whether sensor detection information has been acquired for all the areas in the robot traveling environment shown in FIG. 1.

For example, if sensor detection information has not been acquired in some areas or if sensor detection information has not been sufficiently acquired, No is determined in step S102, and the process returns to step S101 to continue the traveling process of the robot 10 and the process of acquiring sensor detection information.

In step S102, if it is determined that the sensor detection data (learning data) received from the robot 10 has reached the level where a semantic map can be generated, the process advances to step S103.

### (Step S103)

In step S103, the semantic map generation device 50 performs semantics estimation processing as first-stage processing of the semantic map generation processing using the sensor detection data (learning data) received from the robot 10.

Specifically, learning processing is performed using the sensor detection information (environment information) received from the robot 10, a room type is estimated, and classification is performed according to the estimated room type.

### (Step S104)

In step S104, the semantic map generation device 50 generates a semantic map in which feature information corresponding to a class (room type) estimated in step S103, that is, feature information corresponding to a class (room type) obtained from the sensor detection information is recorded as a class attribute (class attribute based on the sensor detection information).

Through these processes, the semantic map is generated as described with reference to FIGS. 10 and 11. In other words, these processes generate the map in which the classes corresponding to the identifiers of room types are set and the semantic map in which the class attributes are recorded as feature information about classes.

An example of semantic map generation processing, in which the door positions of rooms identified by a semantic map are recorded as class attributes, will be described below.

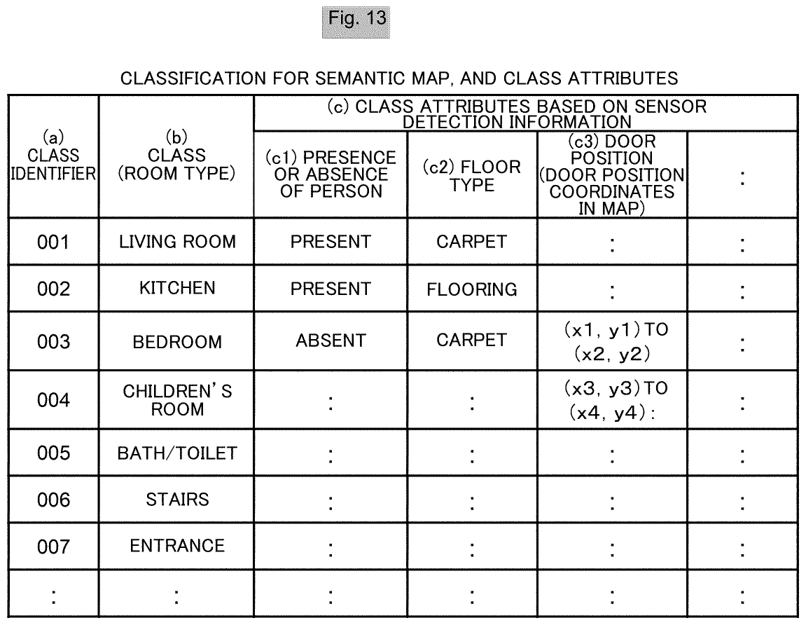

Specifically, for example, the generation of a semantic map, in which class attributes shown in FIG. 13 are recorded, will be described below.

FIG. 13 shows data constituting the semantic map as described with reference to

FIG. 11. FIG. 13 shows the following information.
(a) Class identifier
(b) Class (room type)
(c) Class attributes based on sensor detection information

Among the information of (a) to (c), “(c) class attributes based on sensor detection information” are class attributes that are generated and recorded by the semantic map generation device 50.

In other words, the semantic map generation device 50 analyzes features for classes (room types) on the basis of the sensor detection value of the robot 10, generates class attributes on the basis of analyzed feature information, and records the class attributes.

FIG. 13 shows specific examples of “(c) class attributes based on sensor detection information” as below.
(c1) Presence or absence of person
(c2) Floor type
(c3) Door position (door position coordinates in map)

As described, for example, “(c1) presence or absence of person” is determined on the basis of images captured by the camera that is a sensor of the robot 10 or voice information acquired by a microphone.

Moreover, “(c2) floor type” is determined on the basis of information acquired by a pressure sensor that is a sensor of the robot 10 or traveling sound information acquired by the microphone when the robot travels.

These attributes are class attributes described with reference to FIG. 11.

“(c3) door position (door position coordinates in map)” is information about the door positions of rooms identified by the semantic map.

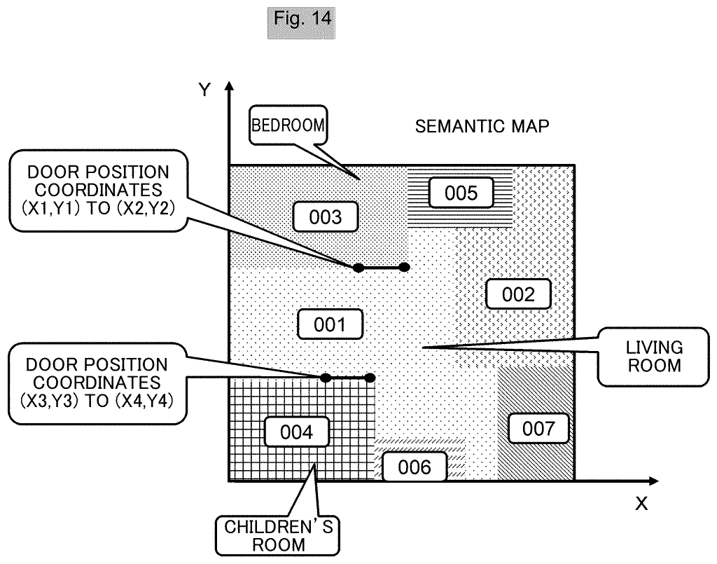

Specifically, for example, the door position of the bedroom and the door position of the children's room in a semantic map shown in FIG. 14 are recorded.

Door position information is recorded using, for example, XY coordinate data in XY coordinates with the origin point located at the lower left end of the semantic map shown in FIG. 14.

The door position information can be obtained by analyzing the sensor detection information of the robot 10, for example, images captured by the camera.

As shown in FIG. 14, the door position of the bedroom is located at (x1,y1) to (x2,y2), and the door position of the children's room is located at (x3,y3) to (x4,y4).

The coordinate position data is recorded as class-corresponding attributes as shown in FIG. 13.

In other words,
door position=(x1,y1) to (x2,y2) is recorded as the class attribute of the bedroom class, and
door position=(x3,y3) to (x4,y4) is recorded as the class attribute of the children's room class.

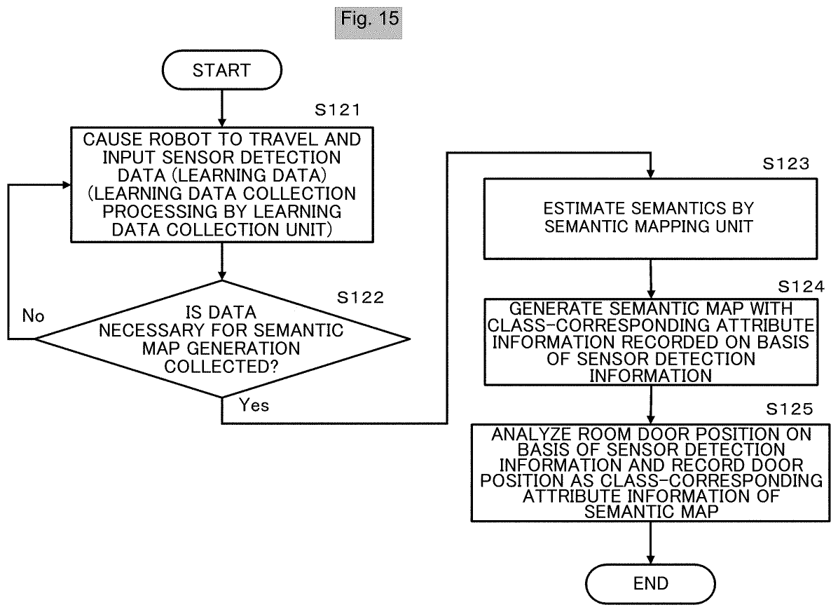

Referring to the flowchart of FIG. 15, the sequence of generating the semantic map including the data of FIG. 13 will be described below.

Processing in the steps of the flow shown in FIG. 15 will be sequentially described below.

### (Steps S121 to S124)

Processing of steps S121 to S124 is the same processing as in steps S101 to S104 of the flowchart described with reference to FIG. 12.

First, in step S121, the semantic map generation device 50 causes the robot 10 to travel and receives sensor detection data (learning data), which is detected by a sensor such as a camera mounted on the robot 10, from the robot 10.

In step S122, it is determined whether the sensor detection data (learning data) received from the robot 10 has reached the level where a semantic map can be generated.

If it is determined that the sensor detection data (learning data) received from the robot 10 has reached the level where a semantic map can be generated, the process advances to step S123.

In step S123, the semantic map generation device 50 performs semantics estimation processing as first-stage processing of the semantic map generation processing using the sensor detection data (learning data) received from the robot 10.

Specifically, learning processing is performed using the sensor detection information (environment information) received from the robot 10, a room type is estimated, and classification is performed according to the estimated room type.

In step S124, the semantic map generation device 50 generates a semantic map in which feature information corresponding to a class (room type) estimated in step S123, that is, feature information corresponding to a class (room type) obtained from the sensor detection information is recorded as a class attribute (class attribute based on the sensor detection information).

### (Step S125)

Moreover, in step S125, the semantic map generation device 50 analyzes the door position of a room on the basis of the sensor detection information and records attribute information corresponding to the classes of the semantic map, that is, door position coordinates as class attributes.

These processes generate the semantic map in which the door position coordinates described with reference to FIG. 13 are recorded as class attributes.

An example of the generation processing of the semantic map, in which the class attributes of the semantic map are recorded as time-corresponding information, will be described below.

Rooms to be identified in the semantic map include a room where a person is present and a room where a person is absent. Moreover, the time zones in which a person is present vary from room to room.

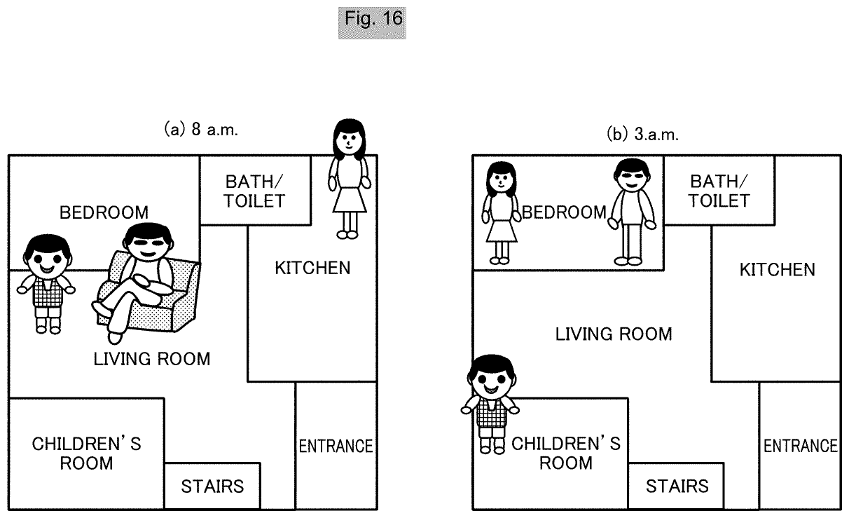

Referring to FIG. 16, a specific example will be described below.

FIG. 16 shows examples of the locations of persons in rooms at two different times.
(a) 8 a.m.
(b) 3 a.m.

(a) 8 a.m. is a morning time when persons are present in the living room and the kitchen.

(b) 3 a.m. is a night time when persons are present in the bedroom and the children's room.

In this way, the locations of persons in the rooms are determined according to the time zone.

As described above, presence/absence information about persons in each room ordinarily varies among time zones. When the presence or absence of persons in a room is recorded as a class attribute of the semantic map, the class attribute is effectively recorded as time-corresponding attribute information.

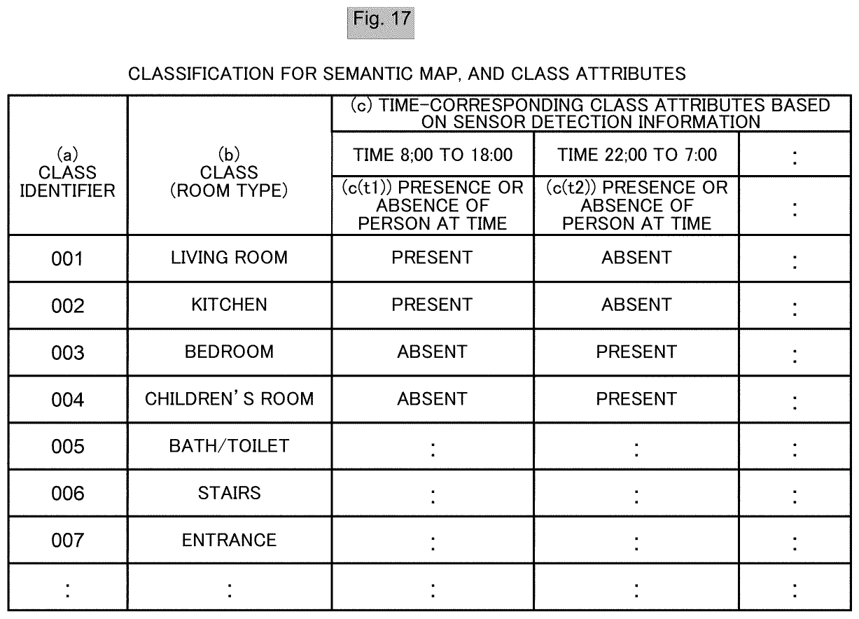

FIG. 17 shows an example of data constituting the semantic map in which class attributes corresponding to times are recorded.

FIG. 17 shows data constituting the semantic map as described with reference to FIGS. 11 and 13. FIG. 17 shows the following information.
(a) Class identifier
(b) Class (room type)
(c) Time-corresponding class attributes based on sensor detection information

Among the information of (a) to (c), “(c) time-corresponding class attributes based on sensor detection information” are class attributes corresponding to times. In the example of FIG. 17, the following time-corresponding class attributes are recorded.
(c(t1)) Presence or absence of person from 8:00 to 18:00
(c(t2)) Presence or absence of person from 22:00 to 7:00

“Presence or absence of person” is determined on the basis of images captured by the camera that is a sensor of the robot 10 or voice information acquired by a microphone.

“(c(t1)) Presence or absence of person from 8:00 to 18:00” is a time-corresponding class attribute that is determined on the basis of images captured by the camera or voice acquired by a microphone when the robot 10 is moved from 8:00 to 18:00.

“(c(t2)) Presence or absence of person from 22:00 to 7:00” is a time-corresponding class attribute that is determined on the basis of images captured by the camera or voice acquired by a microphone when the robot 10 is moved from 22:00 to 7:00.

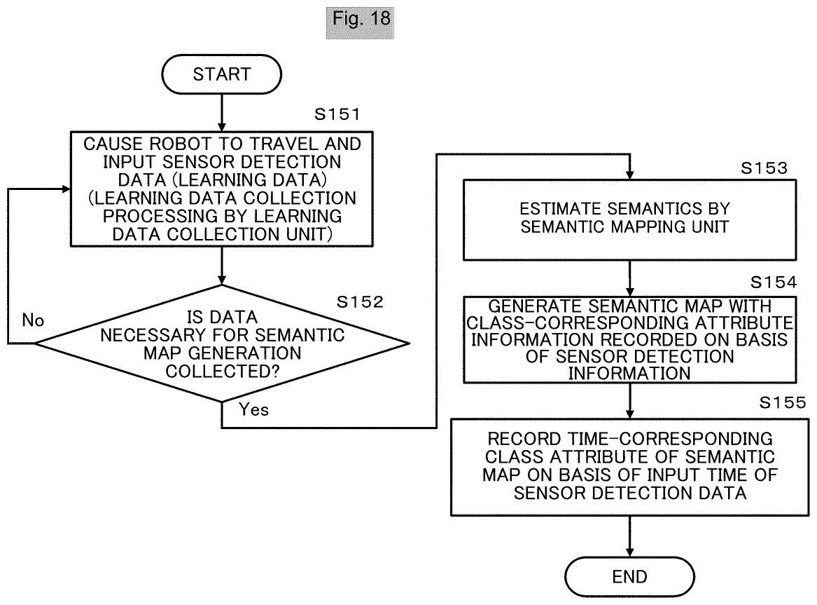

Referring to the flowchart of FIG. 18, the sequence of generating the semantic map including the data of FIG. 17 will be described below.

Processing in the steps of the flow shown in FIG. 18 will be sequentially described below.

### (Steps S151 to S154)

Processing of steps S151 to S154 is the same processing as in steps S101 to S104 of the flowchart described with reference to FIG. 12.

First, in step S151, the semantic map generation device 50 causes the robot 10 to travel and receives sensor detection data (learning data), which is detected by a sensor such as a camera mounted on the robot 10, from the robot 10.

In step S152, it is determined whether the sensor detection data (learning data) received from the robot 10 has reached the level where a semantic map can be generated.

If it is determined that the sensor detection data (learning data) received from the robot 10 has reached data necessary for generating a semantic map, the process advances to step S153.

In step S153, the semantic map generation device 50 performs semantics estimation processing as first-stage processing of the semantic map generation processing using the sensor detection data (learning data) received from the robot 10.

Specifically, learning processing is performed using the sensor detection information (environment information) received from the robot 10, a room type is estimated, and classification is performed according to the estimated room type.

In step S154, the semantic map generation device 50 generates a semantic map in which feature information corresponding to a class (room type) estimated in step S153, that is, feature information corresponding to a class (room type) obtained from the sensor detection information is recorded as a class attribute (class attribute based on the sensor detection information).

### (Step S155)

In step S155, the semantic map generation device 50 further records time-corresponding class attribute information about the semantic map on the basis of the input time of the sensor detection data.

For example, presence/absence information about persons in each class (room) is recorded as time-corresponding class attribute information.

These processes generate the semantic map in which presence/absence information about persons in each class (room) is recorded as time-corresponding class attributes as described with reference to FIG. 17.

### 5. Specific Example of Semantic Map Updating Processing Through Input Processing of Class-Corresponding Attribute Information by User

A specific example of semantic map updating processing through input processing of class-corresponding attribute information by the user will be described below.

A specific example of the processing (step S15) described with reference to the sequence diagrams of FIGS. 5 and 6 will be described below.

In (step S15) described with reference to the sequence diagrams of FIGS. 5 and 6, the user 35 performs semantic map updating processing such that the semantic map received from the semantic map generation device 50 is displayed on the display unit of the controller (mobile object control unit) 30, a user instruction, for example, user instruction information about the setting of a specific room as a restricted area of the robot 10 is input, and the user instruction information is added as a class attribute to the semantic map.

The user instruction information input to the controller 30 by the user 35 is recorded as “user defined class attributes” in the semantic map.

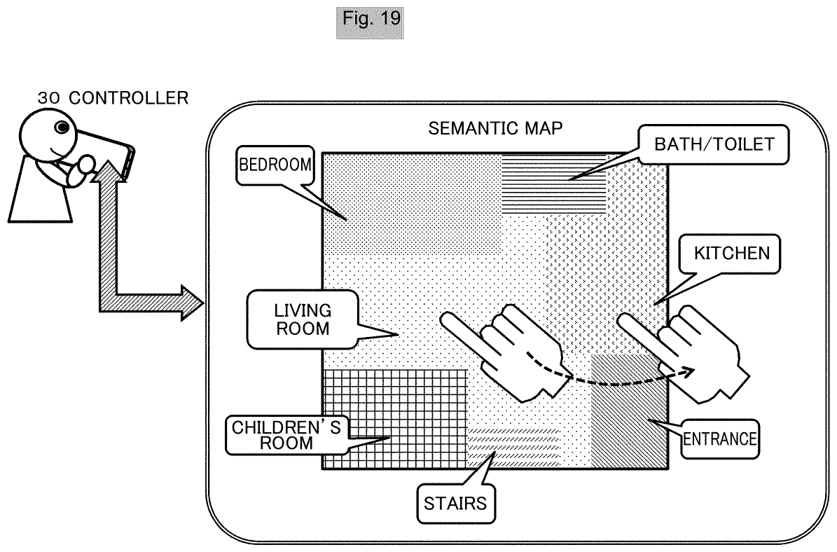

Referring to FIG. 19 and the subsequent drawings, the following examples will be sequentially described below regarding “user defined class attribute” recording processing in the semantic map and a use example of recorded “user defined class attribute.”

(Example 1) Example in which robot operation-enabled area and operation-prohibited area for each class are recorded and used as user-defined class attributes for semantic map for robot moving indoors

(Example 2) Example in which unrestricted area and restricted area for each class are recorded and used as user-defined class attributes for semantic map for robot moving indoors

(Example 3) Example in which unrestricted area and restricted area for each class are recorded and used as user-defined class attributes for semantic map for robot moving outdoors

(Example 4) Example in which movement-enabled area and movement-prohibited area for each class are recorded and used as user-defined class attributes for semantic map for robot moving outdoors

(Example 5) Example in which time-corresponding class attributes are recorded and used as user-defined class attributes for semantic map for robot moving indoors

### (5-1. (Example 1) Example in Which Robot Operation Enabled Area and Operation-Prohibited Area for Each Class are Recorded and Used as User-Defined Class Attributes for Semantic Map for Robot Moving Indoors)

First, as (Example 1), the following describes an example in which a robot operation-enabled area and an operation-prohibited area for each class are recorded and used as user-defined class attributes for the semantic map for the robot moving indoors.

FIG. 19 is an explanatory drawing of a specific example of a user operation when the processing of example 1 is performed in (step S15) described with reference to the sequence diagrams of FIGS. 5 and 6.

In (step S15) described with reference to the sequence diagrams of FIGS. 5 and 6, the user 35 displays the semantic map received from the semantic map generation device 50 on the display unit of the controller (mobile object control unit) 30.

By using the semantic map displayed on the display unit, the user 35 specifies a class (room) displayed according to the color and sets the operation-enabled area and the operation-prohibited area of the robot 10 for each class (room).

Through such a user operation, a user-defined class attribute according to the user operation is added to the semantic map generated by the semantic map generation device 50, and updating processing is performed on the semantic map generated by the semantic map generation device 50.

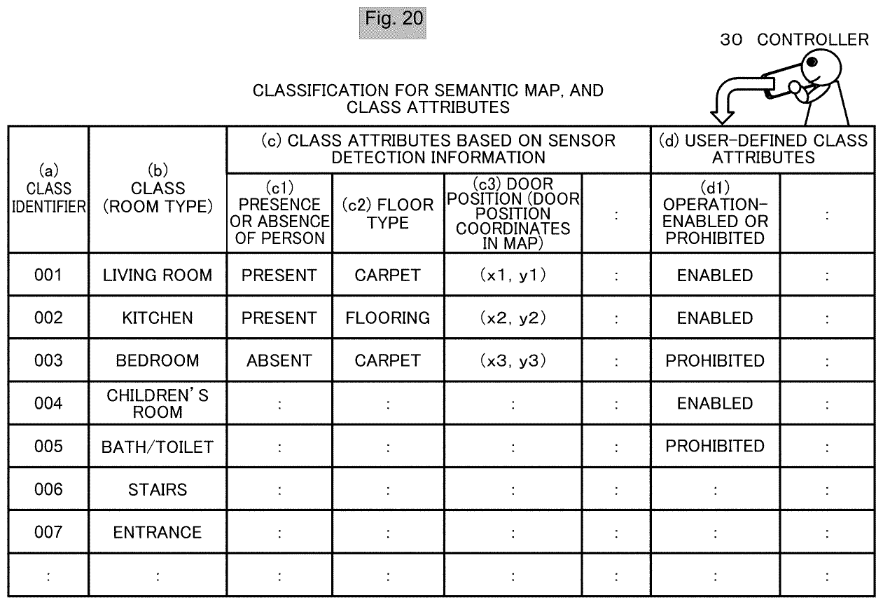

Specifically, in response to a user input, data constituting the semantic map is generated as shown in FIG. 20.

The data constituting the semantic map in FIG. 20 includes the following data:
(a) Class identifier
(b) Class (room type)
(c) Class attributes based on sensor detection information
(d) User-defined class attributes

Among the information (a) to (d), “(c) class attributes based on sensor detection information” are class attributes that are recorded by the semantic map generation device 50 during the generation of the semantic map and are class attributes generated from feature information corresponding to classes (room types) detected by the sensor of the robot 10.

In contrast, among the information (a) to (d), “(d) user-defined class attributes” are class attributes added to the semantic map by the user operation described with reference to FIG. 19.

As described with reference to FIG. 19, the user 35 sets the operation-enabled area and the operation-prohibited area of the robot 10 for each class (room) included in the semantic map displayed on the controller 30.

As a result of the processing, as indicated in “(d) user-defined class attributes” in FIG. 20, the operation-enabled area and the operation-prohibited area of the robot 10 are recorded as the class attributes of classes (rooms) constituting the semantic map, and updating processing is performed on the semantic map.

In the updated semantic map, the following “(d) user-defined class attributes” are set as shown in FIG. 20.
(d1) Class attribute=operation-enabled or prohibited
Class (living room)=enabled
Class (kitchen)=prohibited
Class (bedroom)=prohibited
Class (children's room)=enabled
Class (bath/toilet)=prohibited:

These user-defined class attributes are recorded.

As described above, the user instruction information is additionally recorded as the class attributes of the semantic map, and updating processing is performed on the semantic map generated by the semantic map generation device 50.

The controller 30 transmits a command for requesting the execution of a task, e.g., cleaning to the robot 10 on the basis of the updated semantic map, for example, the semantic map in which operation-enable/prohibition information for each class (room type) shown in FIG. 20 is set as a class attribute.

The robot 10 performs the task (e.g., cleaning) on the basis of the command. The robot 10 performs a task (e.g., cleaning) on the basis of the semantic map updated by the user 35, that is, the semantic map in which operation-enable/prohibition information for each class (room type) is set as a class attribute.

Referring to the user-defined class attributes of the updated semantic map, the robot 10 confirms that two classes, that is, class (bedroom) and class (bath/toilet) are set as robot-operation prohibited areas, sets a traveling route while avoiding the bedroom and the bath/toilet, and performs the task (cleaning).

In this way, the user instruction information is recorded as the class attributes of the semantic map, thereby operating the robot 10 according to the intention of the user.

### (5-2. (Example 2) Example in Which Unrestricted Area and Restricted Area for Each Class are Recorded and Used as User-Defined Class Attributes for Semantic Map for Robot Moving Indoors)

As (Example 2), the following will describe an example in which an unrestricted area and a restricted area for each class are recorded and used as user-defined class attributes for the semantic map for the robot moving indoors.

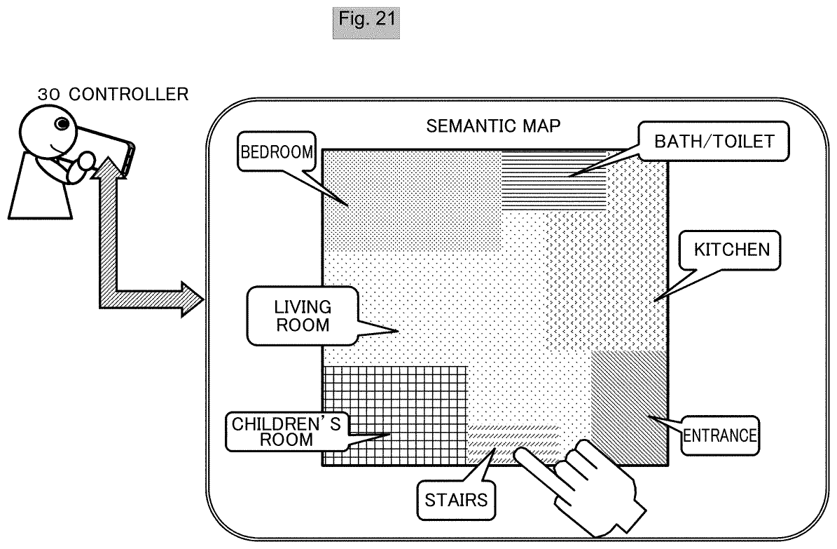

FIG. 21 is an explanatory drawing of a specific example of a user operation when the processing of example 2 is performed.

The user 35 displays the semantic map received from the semantic map generation device 50 on the display unit of the controller (mobile object control unit) 30, uses the displayed semantic map to specify a class (room) displayed according to the color, and sets an unrestricted area and a restricted area of the robot 10 for each class (room).

Such a user operation adds user-defined class attributes to the semantic map generated by the semantic map generation device 50, so that the semantic map is updated.

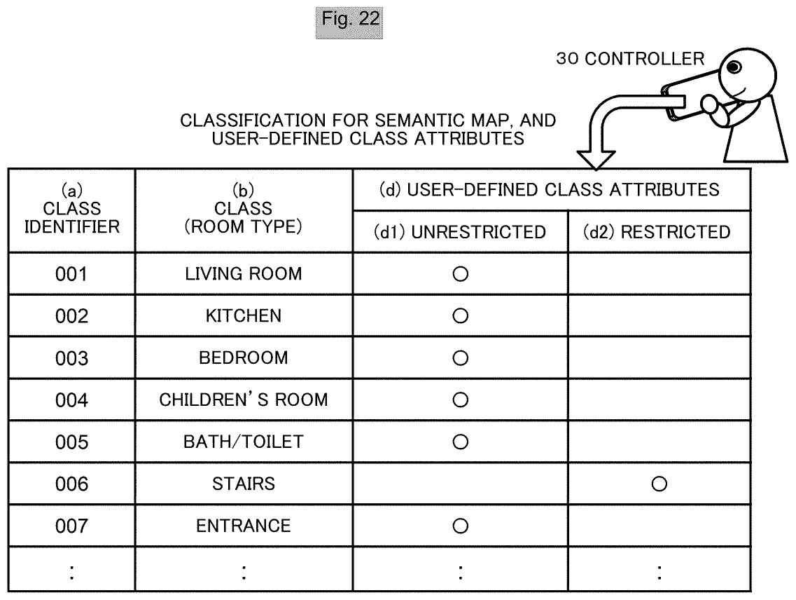

Specifically, (d) user-defined class attributes are added as shown in FIG. 22. Data constituting the semantic map in FIG. 22 only indicates (a) class identifier, (b) class (room type), and (d) user-defined class attributes.

Omitted is “(c) class attributes based on sensor detection information” that are class attributes recorded when the semantic map generation device 50 generates the semantic map.

In the data constituting the semantic map in FIG. 22, “(d) user-defined class attributes” are class attributes added to the semantic map by the user operation described with reference to FIG. 21.

In the updated semantic map, the following “(d) user-defined class attributes” are set as shown in FIG. 22.
For (d1) Class attribute=unrestricted,
Class (living room)=unrestricted
Class (kitchen)=unrestricted
Class (bedroom)=unrestricted
Class (children's room)=unrestricted
Class (bath/toilet)=unrestricted
Class (entrance)=unrestricted:

For (d2) class attribute=restricted
Class (stairs)=restricted

These user-defined class attributes are recorded.

In this way, the user instruction information is additionally recorded as the class attributes of the semantic map, so that the updated semantic map is generated. The controller 30 transmits a command for requesting the execution of a task, e.g., cleaning to the robot 10 on the basis of the updated semantic map, for example, the semantic map in which no-restriction/restriction information for each class (room type) shown in FIG. 22 is set as a class attribute.

The robot 10 performs the task (e.g., cleaning) on the basis of the command. The robot 10 performs a task (e.g., cleaning) on the basis of the semantic map updated by the user 35, that is, the semantic map in which no-restriction/restriction information for each class (room type) is set as a class attribute.

Referring to the user-defined class attributes of the updated semantic map, the robot 10 confirms that class (stairs) is set as a robot restricted area, sets a traveling route while avoiding the stairs, and performs the task (cleaning).

In this way, the user instruction information is recorded as the class attributes of the semantic map, thereby operating the robot 10 according to the intention of the user.

### (5-3. (Example 3) Example in Which Accessible Area and Inaccessible Area for Each Class are Recorded and Used as User-Defined Class Attributes for Semantic Map for Robot Moving Outdoors)

As (Example 3), the following will describe an example in which an accessible area and an inaccessible area for each class are recorded and used as user-defined class attributes for the semantic map for the robot moving outdoors.

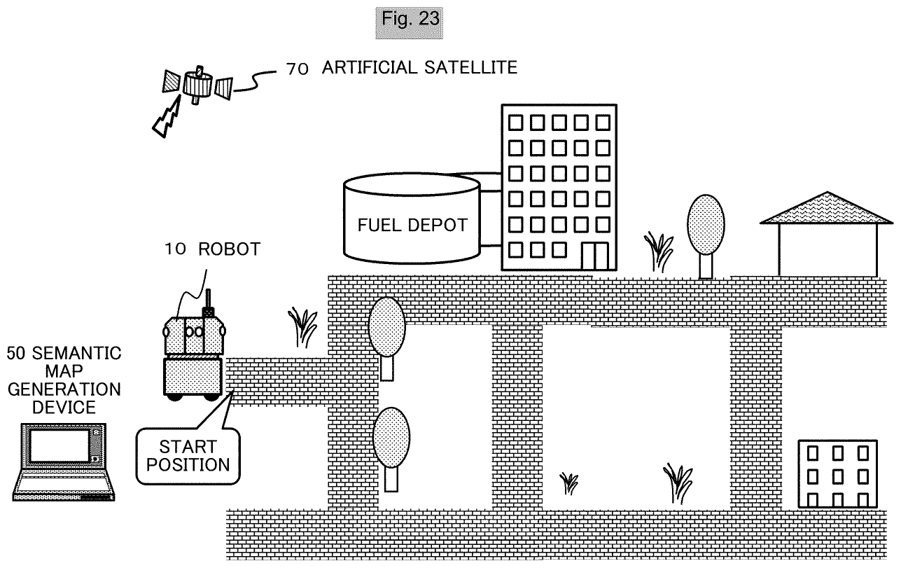

FIG. 23 shows an example of the robot 10 of example 3, that is, the robot 10 moving outdoors and a robot movement area.

First, the semantic map generation device 50 generates the map of an area where the robot 10 travels, by using images captured by an artificial satellite 70. The generated map is a base map for generating a semantic map.

Thereafter, the robot 10 travels in the outdoor traveling environment shown in FIG. 23 by using the map generated by the semantic map generation device 50 and acquires sensor detection information (environment information).

As described above, the robot 10 is equipped with a camera or sensors such as a LiDAR (Light Detection and Ranging), which is a sensor for measuring a distance to an obstacle with a laser beam. Sensor detection information acquired by these sensors is transmitted to the semantic map generation device 50.

The semantic map generation device 50 performs learning processing using the sensor detection information received from the robot 10 and generates the semantic map.

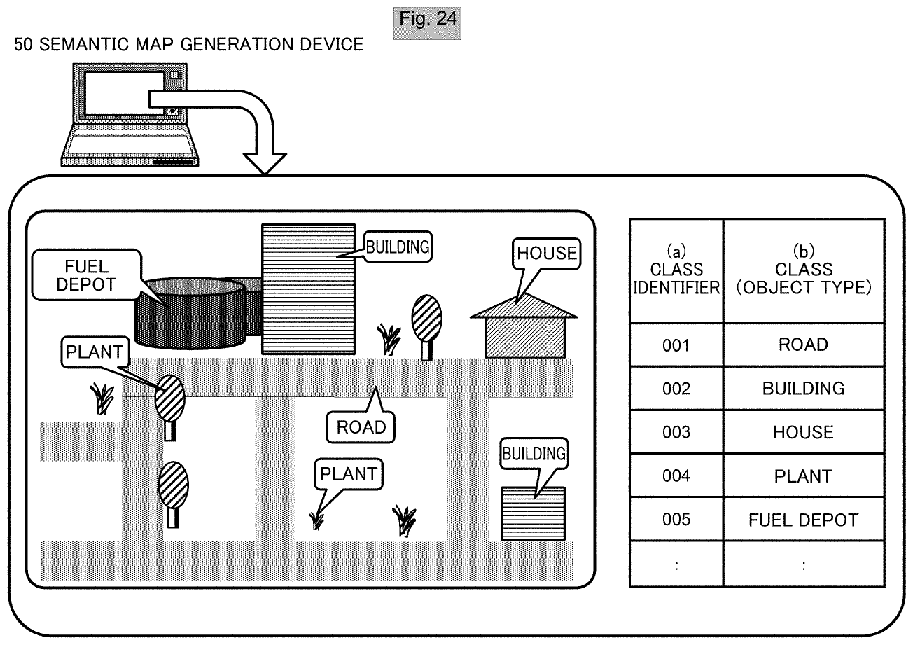

For example, the semantic map is generated as shown in FIG. 24.

For example, as shown in FIG. 24, the semantic map is generated as a map classified as follows:
Class with class identifier 001 (object type)=road
Class with class identifier 002 (object type)=building
Class with class identifier 003 (object type)=house
Class with class identifier 004 (object type)=plant
Class with class identifier 005 (object type)=fuel depot

In this way, the classes are set for the respective object types in the semantic map generated by the semantic map generation device 50.

The semantic map generated by the semantic map generation device 50 is transmitted to the controller 30 operated by the user 35.

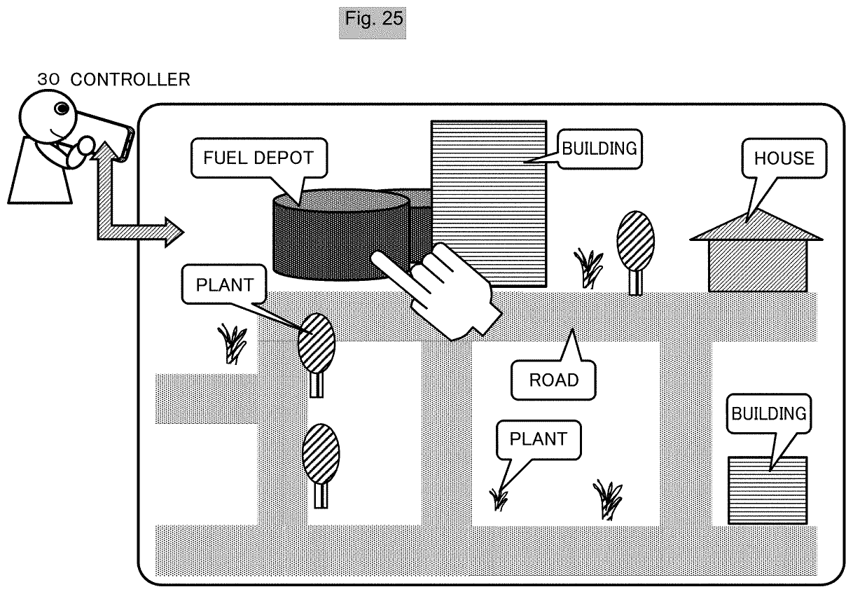

As shown in FIG. 25, the user 35 displays the semantic map received from the semantic map generation device 50 on the display unit of the controller (mobile object control unit) 30, uses the displayed semantic map to specify a class (object) displayed according to the color, and sets an accessible area and an inaccessible area of the robot 10 for each class (object).

The user sets, for example, the class (fuel depot) as an inaccessible area.

In response to such a user operation, user-defined class attributes corresponding to the user operation are added to the semantic map generated by the semantic map generation device 50, so that the semantic map is updated.

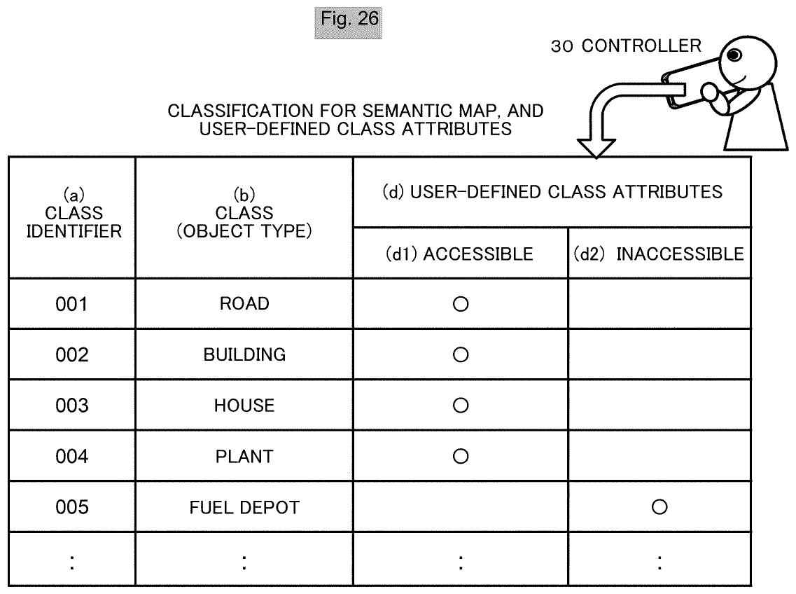

Specifically, (d) user-defined class attributes are added as shown in FIG. 26. In data constituting the semantic map in FIG. 26, “(d) user-defined class attributes” are class attributes added to the semantic map by the user operation described with reference to FIG. 25.

In the updated semantic map, the following “(d) user-defined class attributes” are set as shown in FIG. 26.
For (d1) class attribute=accessible,
Class (road)=accessible
Class (building)=accessible
Class (house)=accessible
Class (plant)=accessible:

Furthermore, for (d2) class attribute=inaccessible,
Class (fuel depot)=inaccessible

These user-defined class attributes are recorded.

In this way, the user instruction information is additionally recorded as the class attributes of the semantic map, so that the updated semantic map is generated. The controller 30 transmits a command for requesting the execution of a task, e.g., package delivery to the robot 10 on the basis of the updated semantic map, for example, the semantic map in which accessibility/inaccessibility information for each class (object) shown in FIG. 26 is set as a class attribute.

The robot 10 performs the task (e.g., package delivery) on the basis of the command. The robot 10 performs a task (e.g., package delivery) on the basis of the semantic map updated by the user 35, that is, the semantic map in which accessibility/inaccessibility information for each class (object) is set as a class attribute.

Referring to the user-defined class attributes of the updated semantic map, the robot 10 confirms that class (fuel depot) is set as a robot inaccessible area, sets a traveling route while avoiding the fuel depot, and performs the task (package delivery).

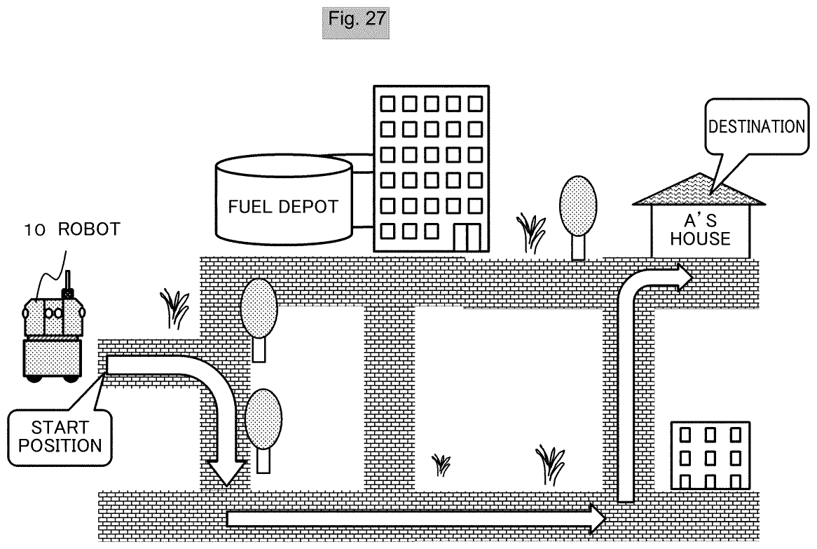

For example, as shown in FIG. 27, when the destination of package delivery is the house of Mr./Ms. A, the task (package delivery) is performed after a traveling route is set while avoiding the fuel depot as indicated by arrows on the road.

In this way, the user instruction information is recorded as the class attributes of the semantic map, thereby operating the robot 10 according to the intention of the user.

(5-4. (Example 4) Example in Which Movement-Enabled Area and Movement-Prohibited Area for Each Class are Recorded and Used as User-Defined Class Attributes for Semantic Map for robot moving outdoors)

As (Example 4), the following will describe an example in which a movement-enabled area and a movement-prohibited area for each class are recorded and used as user-defined class attributes for the semantic map for the robot moving outdoors.

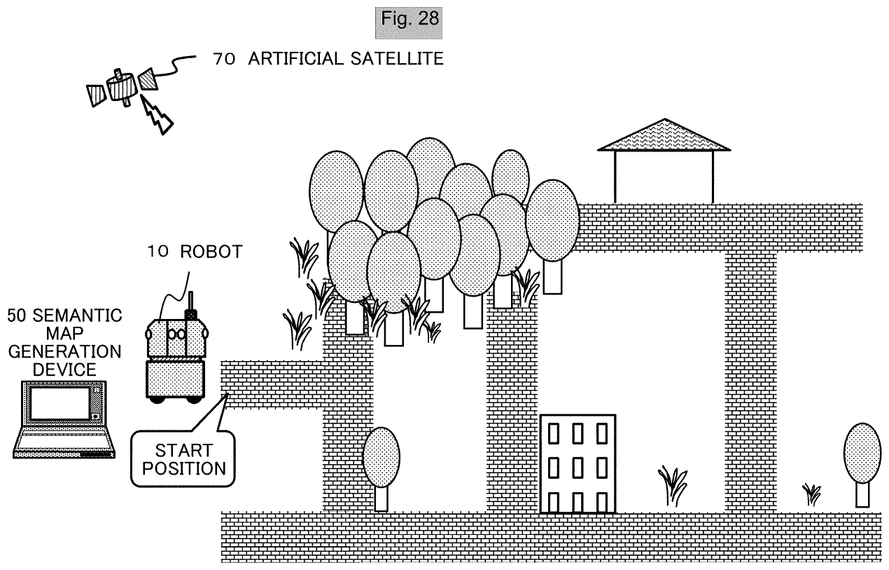

FIG. 28 shows an example of the robot 10 of example 4, that is, the robot 10 moving outdoors and a robot movement-enabled area.

First, the semantic map generation device 50 generates the map of an area where the robot 10 travels, by using images captured by an artificial satellite 70. The generated map is a base map for generating a semantic map.

Thereafter, the robot 10 travels in the outdoor traveling environment shown in FIG. 28 by using the map generated by the semantic map generation device 50 and acquires sensor detection information (environment information).

As described above, the robot 10 is equipped with a camera or sensors such as a LiDAR (Light Detection and Ranging), which is a sensor for measuring a distance to an obstacle with a laser beam. Sensor detection information acquired by these sensors is transmitted to the semantic map generation device 50.

The semantic map generation device 50 performs learning processing using the sensor detection information received from the robot 10 and generates the semantic map.

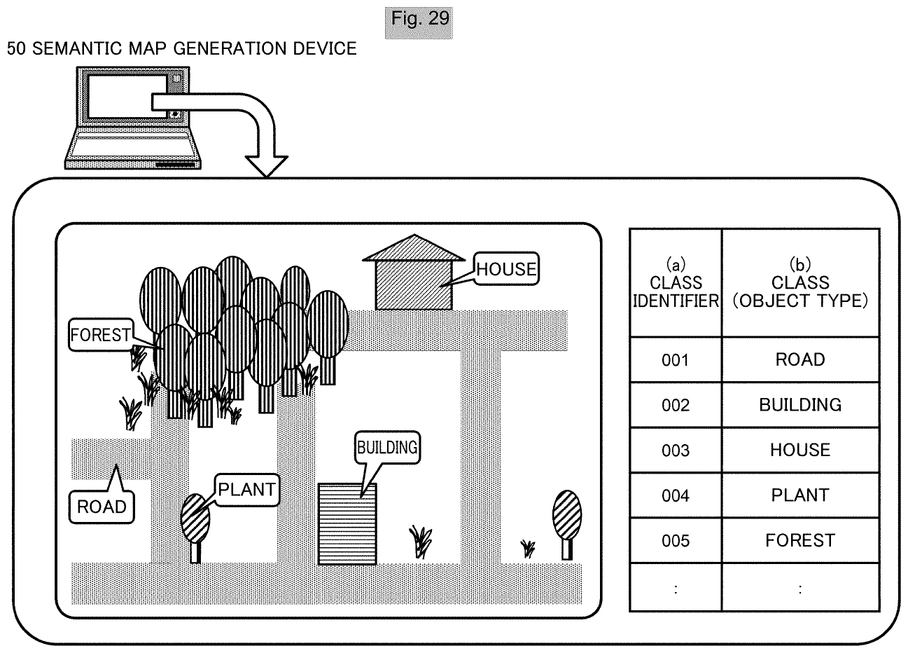

For example, the semantic map is generated as shown in FIG. 29.

For example, as shown in FIG. 29, the semantic map is generated as a map classified as follows:
Class with class identifier 001 (object type)=road
Class with class identifier 002 (object type)=building
Class with class identifier 003 (object type)=house
Class with class identifier 004 (object type)=plant
Class with class identifier 005 (object type)=forest

In this way, the classes are set for the respective object types in the semantic map generated by the semantic map generation device 50.

The semantic map generated by the semantic map generation device 50 is transmitted to the controller 30 operated by the user 35.

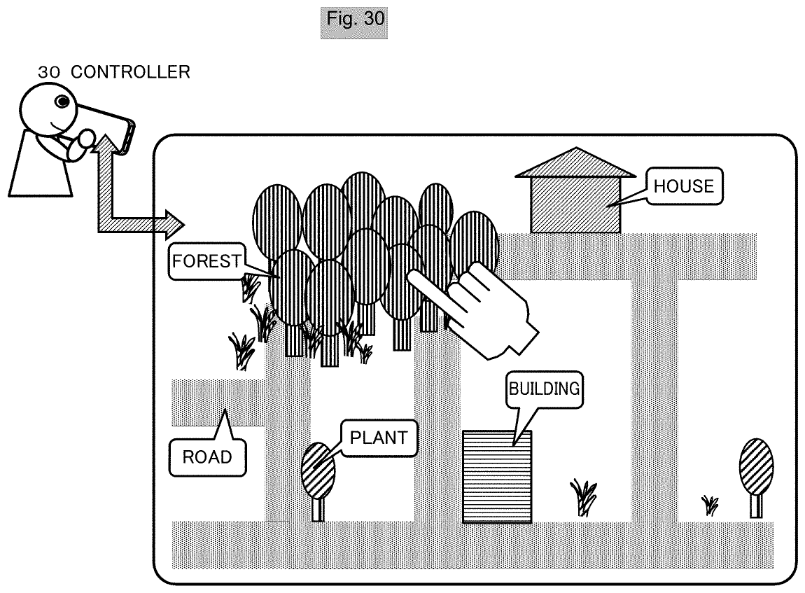

As shown in FIG. 30, the user 35 displays the semantic map received from the semantic map generation device 50 on the display unit of the controller (mobile object control unit) 30, uses the displayed semantic map to specify a class (object) displayed according to the color, and sets a movement-enabled area and a movement-prohibited area of the robot 10 for each class (object).

The user sets, for example, the class (forest) as a movement-prohibited area.

In response to such a user operation, user-defined class attributes corresponding to the user operation are added to the semantic map generated by the semantic map generation device 50, so that the semantic map is updated.

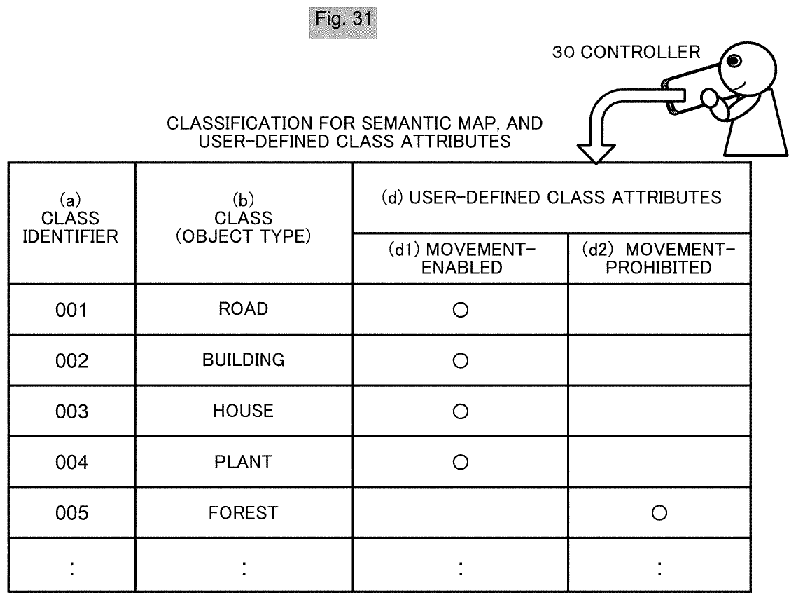

Specifically, (d) user-defined class attributes are added as shown in FIG. 31.

In data constituting the semantic map in FIG. 31, “(d) user-defined class attributes” are class attributes added to the semantic map by the user operation described with reference to FIG. 30.

In the updated semantic map, the following “(d) user-defined class attributes” are set as shown in FIG. 31.
For (d1) class attribute=movement-enabled,
Class (road)=enabled
Class (building)=enabled
Class (house)=enabled
Class (plant)=enabled:

Furthermore, for (d2) class attribute=movement-prohibited,
Class (forest)=prohibited

These user-defined class attributes are recorded.

In this way, the user instruction information is additionally recorded as the class attributes of the semantic map, so that the updated semantic map is generated. The controller 30 transmits a command for requesting the execution of a task, e.g., package delivery to the robot 10 on the basis of the updated semantic map, for example, the semantic map in which movement-enable/prohibition information for each class (object) shown in FIG. 31 is set as a class attribute.

The robot 10 performs the task (e.g., package delivery) on the basis of the command. The robot 10 performs a task (e.g., package delivery) on the basis of the semantic map updated by the user 35, that is, the semantic map in which movement-enable/prohibition information for each class (object) is set as a class attribute.

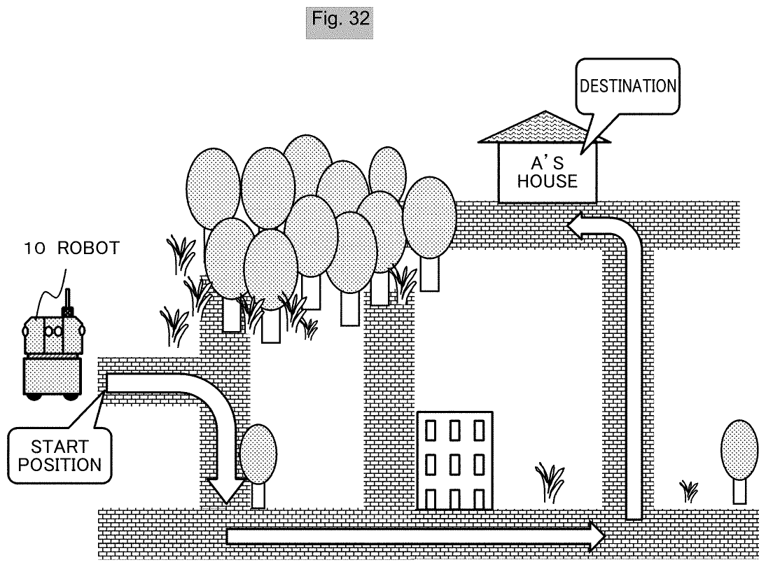

Referring to the user-defined class attributes of the updated semantic map, the robot 10 confirms that class (forest) is set as a robot movement-prohibited area, sets a traveling route while avoiding forest, and performs the task (package delivery). For example, as shown in FIG. 32, when the destination of package delivery is the house of Mr./Ms. A, the task (package delivery) is performed after a traveling route is set while avoiding forest as indicated by arrows on the road.

In this way, the user instruction information is recorded as the class attributes of the semantic map, thereby operating the robot 10 according to the intention of the user.

### (5-5. (Example 5) Example in Which Time-Corresponding Class Attributes are Recorded and Used as User-Defined Class Attributes for Semantic Map for Robot Moving Indoors)

As (Example 5), the following describes an example in which time-corresponding class attributes are recorded and used as user-defined class attributes for the semantic map for the robot moving indoors.

As described with reference to FIGS. 16 to 18, the process of generating and setting time-corresponding class attributes is performed when the semantic map generation device 50 records “class attributes based on sensor detection information” in the semantic map.

The user 35 can also add user-defined class attributes as time-corresponding class attributes to the semantic map.

Example 5 is a processing example of the addition and recording of time-corresponding class attributes by the user.

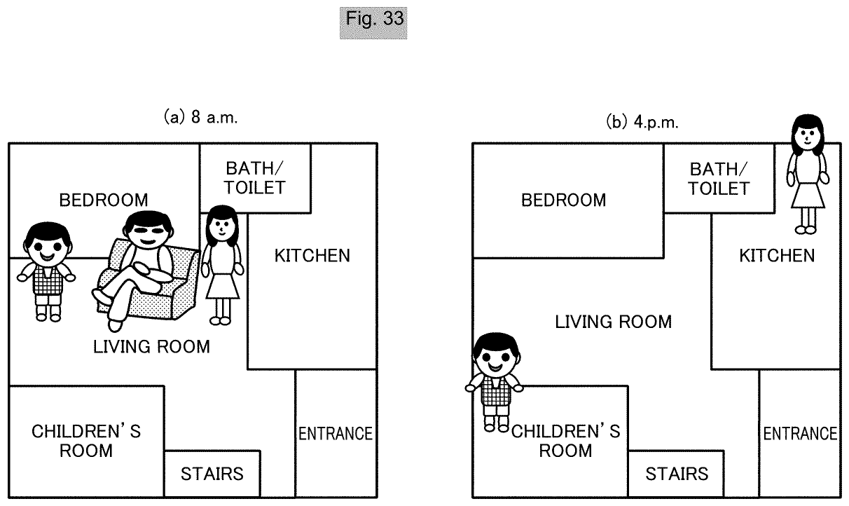

For example, as shown in FIG. 33, the time zones in which persons are present in rooms to be identified in the semantic map vary from room to room.

FIG. 33 shows examples of the locations of persons in rooms at two different times.
(a) 8 a.m.
(b) 4 p.m.

(a) 8 a.m. is a morning time when persons are present in the living room.

(b) 4 p.m. is an evening time when persons are present in the kitchen and the children's room.

In this way, the locations of persons in the rooms are determined according to the time zone.

When user-defined attributes are additionally recorded in the semantic map generated by the semantic map generation device 50, the user 35 records the user-defined attributes as time-corresponding attribute information.

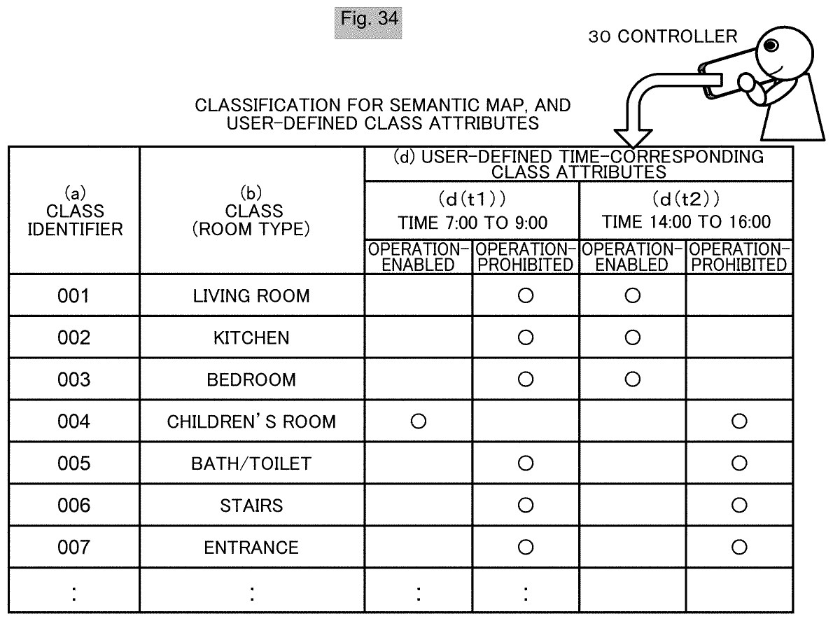

FIG. 34 shows an example of data constituting the semantic map in which user-defined class attributes corresponding to times are recorded.

FIG. 34 shows data constituting the semantic map in which “(d) user-defined time-corresponding class attributes” are additionally recorded.

“(d) user-defined time-corresponding class attributes” in FIG. 34 are time-corresponding class attributes set by the user 35. In the example of FIG. 34, the following time-corresponding class attributes are recorded.
(d(t1)) operation-enable/prohibition information from time 7:00 to 9:00
(d(t2)) operation-enable/prohibition information from time 14:00 to 16:00

The controller 30 transmits a command for requesting the execution of a task, e.g., cleaning to the robot 10 on the basis of the updated semantic map, for example, the semantic map in which operation-enable/prohibition information for each class is set as a time-corresponding class attribute as shown in FIG. 34.

The robot 10 performs the task (e.g., cleaning) on the basis of the command.

The robot 10 performs a task (e.g., cleaning) on the basis of the semantic map updated by the user 35, that is, the semantic map in which operation-enable/prohibition information for each class (room type) at each time is set as a class attribute.

Referring to the user-defined time-corresponding class attributes of the updated semantic map, the robot 10 selects the user-defined time-corresponding class attribute to be used according to the execution time of the task (cleaning), and then performs the task (cleaning).

For example, when the execution time of the task (cleaning) is 8:00, from among the user-defined time-corresponding class attributes of the semantic map, the robot 10 refers to the following time-corresponding class attribute.
(d(t1)) operation-enable/prohibition information from time 7:00 to 9:00

Referring to the time-corresponding class attributes, the robot 10 then confirms that only class (children's room) is set as a robot operation-enabled area, sets a traveling route for cleaning the children's room, and performs the task (cleaning).

When the execution time of the task (cleaning) is 15:00, from among the user-defined time-corresponding class attributes of the semantic map, the robot 10 refers to the following time-corresponding class attribute.
(d(t2)) operation-enable/prohibition information from time 14:00 to 16:00

Referring to the time-corresponding class attributes, the robot 10 confirms that class (living room), class (kitchen), and class (bedroom) are set as robot operation-enabled areas, sets a traveling route for cleaning the rooms, and performs the task (cleaning).

In this way, the user instruction information is recorded as the class attributes of the semantic map, thereby operating the robot 10 according to the intention of the user.

### 6. Configuration Examples of Each Device

The configuration examples of the devices will be described below.

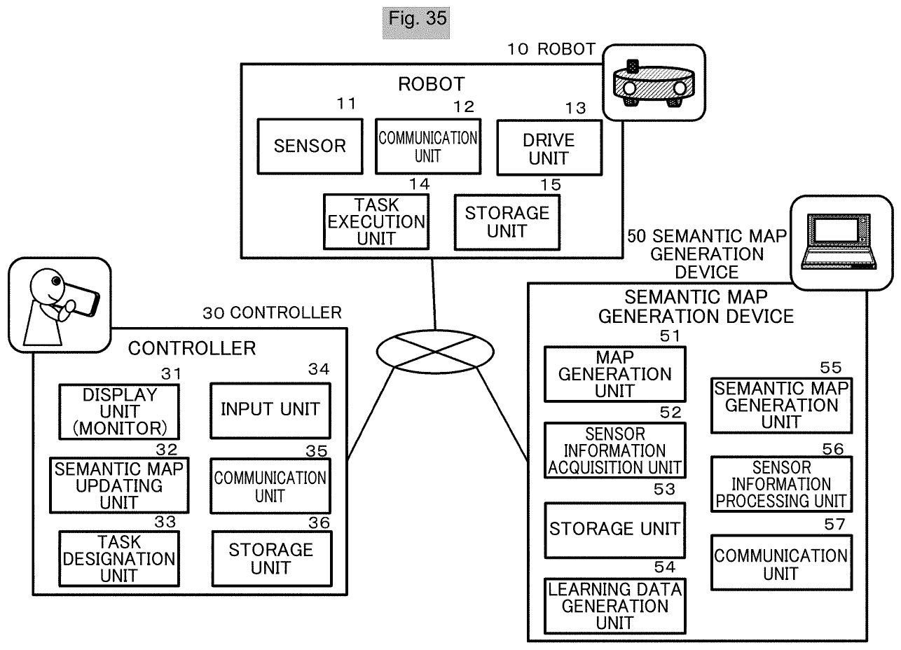

FIG. 35 shows a configuration example of each of the robot 10, the controller 30, and the semantic map generation device 50.

As shown in FIG. 35, the robot 10 includes a sensor 11, a communication unit 12, a drive unit 13, a task execution unit 14, and a storage unit 15.

The controller 30 includes a display unit (monitor) 31, a semantic map updating unit 32, a task designation unit 33, an input unit 34, a communication unit 35, and a storage unit 36.

The semantic map generation device 50 includes a map generation unit 51, a sensor information acquisition unit 52, a storage unit 53, a learning data generation unit 54, a semantic map generation unit 55, a sensor information processing unit 56, and a communication unit 57.

For example, the sensor 11 of the robot 10 includes a camera and various sensors such as a LiDAR (Light Detection and Ranging), which is a sensor for measuring a distance to an obstacle with a laser beam, an IMU (inertial measurement unit (Inertial Measurement Unit)) that detects the acceleration and the angular velocity or the like of the robot, an odometry device that detects, for example, the number of revolutions of a robot tire, an illuminance sensor for detecting the brightness of a room, a microphone that acquires voice information about surroundings, and a pressure sensor that acquires information for estimating the hardness, softness, and material or the like of a floor.

The communication unit 12 performs communications with the controller 30 and the semantic map generation device 50.

The drive unit 13 performs robot driving processing for executing various tasks such as a movement of the robot 10.

The task execution unit 14 performs control for causing the robot 10 to execute a task according to a task execution command input from the controller 30 or the like. The storage unit 15 stores the program of the task executed by the robot 10, a control parameter, commands and semantic maps that are input from the controller 30 and the semantic map generation device 50 and the like, and various other types of data such as map information.

The display unit (monitor) 31 of the controller 30 displays, for example, a semantic map input from the semantic map generation device 50.

The display unit 31 also functions as a touch-panel input unit.

The semantic map updating unit 32 performs updating processing on the semantic map on the basis of information input by the user according to the semantic map displayed on the display unit 31, for example, user-defined class attributes.

The task designation unit 33 designates a task to be executed by the robot 10, for example, tasks such as cleaning or package delivery.

The input unit 34 is used for, for example, transmitting a task execution command and inputting user-defined task information to the semantic map displayed on the display unit 31.

The communication unit 35 performs communications with the robot 10 and the semantic map generation device 50.

The storage unit 36 stores the semantic map received from the semantic map generation device 50, the updated semantic map in which class attributes input by the user are recorded, various task execution commands, and robot control parameters or the like.

The map generation unit 51 of the semantic map generation device 50 generates a map as a base map for generating a semantic map, for example, an occupied-grid map described with reference to FIG. 7, a three-dimensional point group map described with reference to FIG. 8, or other maps. Alternatively, the process of acquiring maps from the outside is performed.

The sensor information acquisition unit 52 acquires sensor detection information, which is acquired by the sensor 11 of the robot 10, through the communication unit 57.

The storage unit 53 stores a map generated by the map generation unit 51, the semantic map, and various other types of data.

The learning data generation unit 54 generates learning data necessary for semantic map generation processing.

The learning data is generated on the basis of, for example, the sensor detection information acquired by the sensor 11 of the robot 10.

The semantic map generation unit 55 generates a semantic map by performing learning processing using the learning data generated by the learning data generation unit 54.

As described above, the semantic map is generated by semantic mapping.

Semantic mapping is the process of identifying the type of class to which each coordinate in the map of an environment managed by the robot 10 belongs. For example, a class is set according to the type of identified object, and a color and an identifier are set according to the object type (=class).

Semantic mapping can be performed using, for example, a learning model that applies algorithms such as a deep neural network (DNN: Deap Neural Network), which is a multi-layered neural network, a convolutional neural network (CNN: Convolutional Neural Network), or a recurrent neural network (RNN: Recurrent Neural Network), and identifies an object corresponding to each pixel on the basis of, for example, a feature amount obtained from an image.

For example, the semantic map generation unit 55 identifies a room in the traveling environment where the robot 10 travels, and generates a semantic map where a class corresponding to the type of identified room is set.

The sensor information processing unit 56 generates processing information based on the detection value of the sensor of the robot 10. For example, processing is performed to extract feature points from an image captured as the detection value of a camera that is a sensor of the robot 10. The feature point data is input to the semantic map generation unit 55 and is used for semantic map generation processing.

The communication unit 57 performs communications with the robot 10 and the controller 30.

The system configuration shown in FIG. 35 is configured such that the robot 10, the controller 30, and the semantic map generation device 50 can communicate with one another.

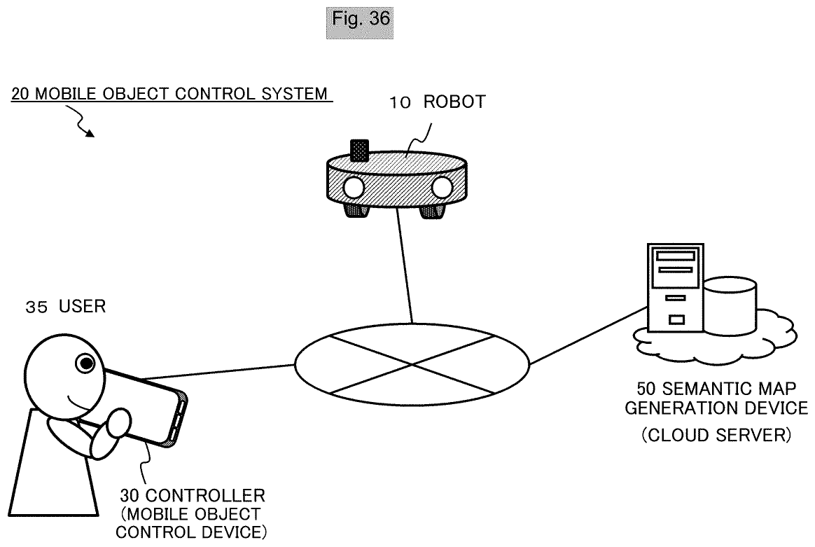

In these configurations, for example, the semantic map generation device 50 may be set as a cloud server as shown in FIG. 36.

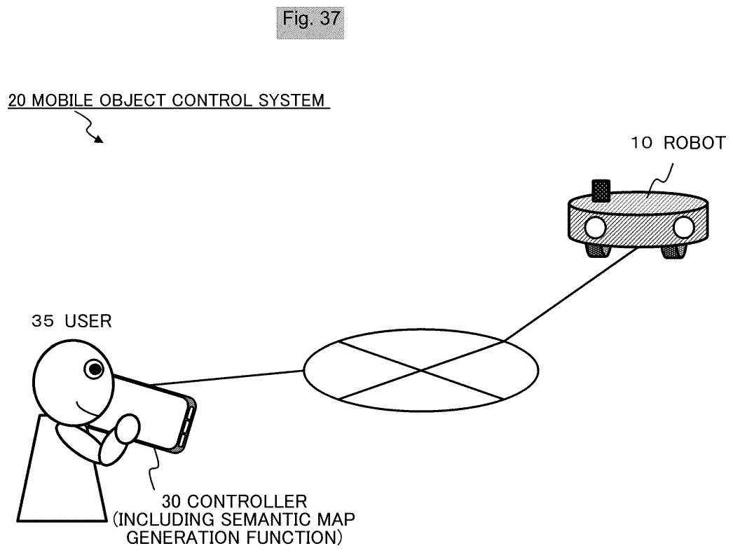

Moreover, the controller 30 and the semantic map generation device 50 may be configured integrally. For example, as shown in FIG. 37, the controller 30 is configured with the functions of the semantic map generation device 50.

In the system shown in FIG. 37, for example, the controller 30 performs all the processes of generating a semantic map and setting user-defined class attributes. In the configuration of FIG. 37, the processing unit of the semantic map generation device 50, which has been described with reference to FIG. 35, is configured in the controller 30.

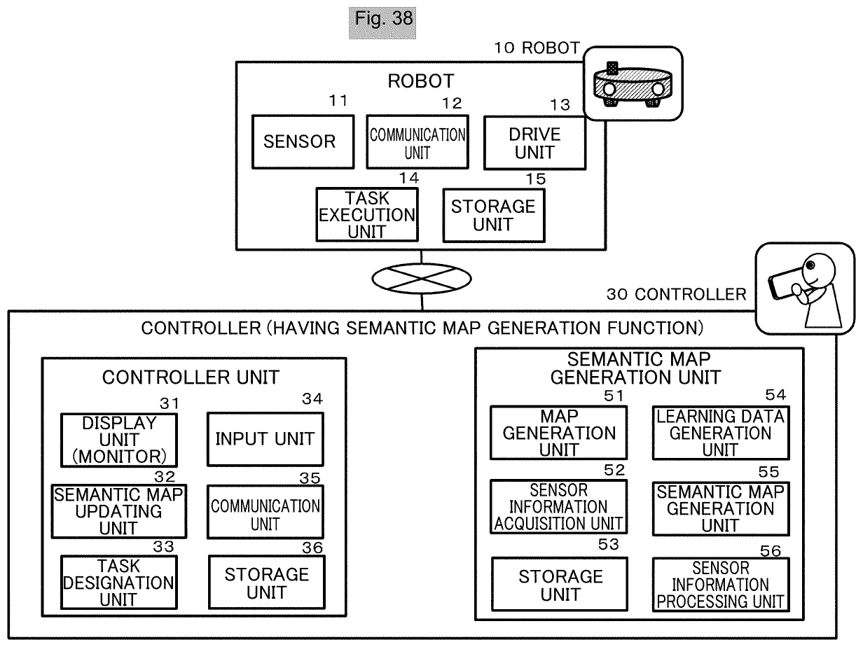

In other words, specifically, the map generation unit 51, the sensor information acquisition unit 52, the storage unit 53, the learning data generation unit 54, the semantic map generation unit 55, and the sensor information processing unit 56 are configured in the controller 30 as shown in FIG. 38.

### 7. Hardware Configuration Example of Each Device

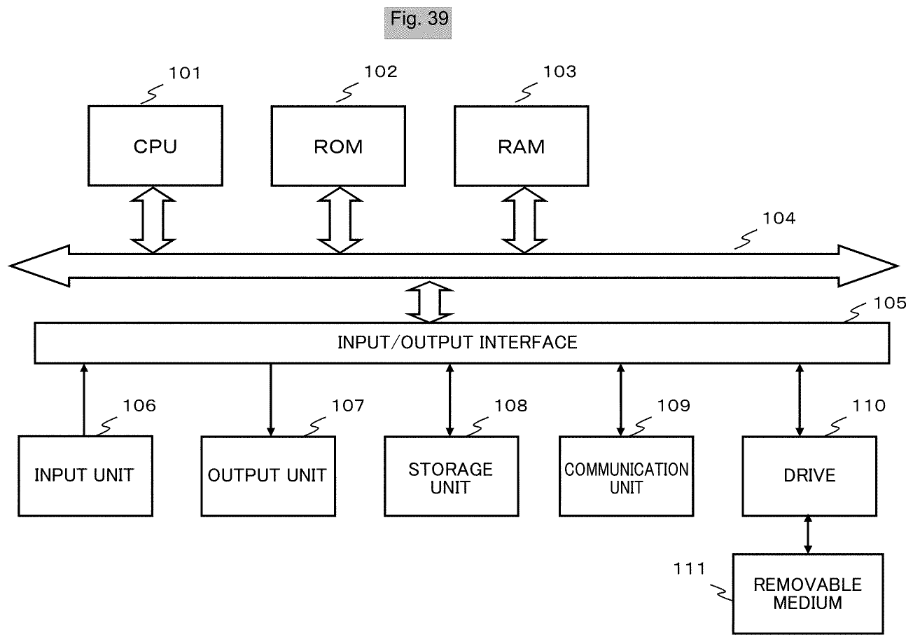

Referring to FIG. 39, a hardware configuration example of the robot 10, the controller 30, and the semantic map generation device 50 will be described below. A hardware configuration in FIG. 39 shows an example of a hardware configuration applicable to these devices.

Each configuration of hardware in FIG. 39 will be described below.

A CPU (Central Processing Unit) 101 functions as a data processing unit that executes various kinds of processing according to programs stored in a ROM (Read Only Memory) 102 or a storage unit 108. For example, the processing according to the sequence described in the above embodiment is executed. A RAM (Random Access Memory) 103 stores programs executed by the CPU 101 and data. The CPU 101, the ROM 102, and the RAM 103 are connected to one another via a bus 104.

The CPU 101 is connected to an input/output interface 105 via the bus 104, and the input/output interface 105 is connected to an input unit 106 including various switches, a keyboard, a touch panel, a mouse, and a microphone and an output unit 107 including a display and a speaker.

The storage unit 108 connected to the input/output interface 105 is composed of, for example, a hard disk or the like, and stores a program executed by the CPU 101 and various pieces of data. A communication unit 109 functions as a transmission and reception unit for data communications via a network such as the Internet or a local area network, and communicates with an external device.

A drive 110 connected to the input/output interface 105 drives a removable medium 111 such as a magnetic disk, an optical disc, a magneto-optical disc, or a semiconductor memory such as a memory card, and records or reads data.

### 8. Summary of Configuration of Present Disclosure

The examples of the present disclosure have been described above in detail with reference to a specific example. However, it will be apparent to those skilled in the art that modification and substation of the embodiments can be made without departing from the gist of the technology disclosed in the present disclosure. In other words, the present invention has been disclosed according to an illustrative form, but the present disclosure should not be restrictively construed. The gist of the present disclosure should be determined in consideration of the claims.

The technique disclosed in the present specification can be configured as follows:

(1) A mobile object control information generation method executed in a mobile object control information generation device,
the method including:
generating, by a data processing unit, mobile object control information in which feature information about a class or mobile object control information about the class is recorded as class attributes in association with the class serving as segmented areas in the map of the traveling area of a mobile object.

(2) The mobile object control information generation method according to (1), wherein the map is a semantic map generated by semantic mapping.

(3) The mobile object control information generation method according to (1) or (2), wherein the map is a map that allows identification of a room type in the indoor traveling area of the mobile object and the border between rooms, and the class is a class set for each room.

(4) The mobile object control information generation method according to any one of (1) to (3), wherein the map is a map that allows identification of an object in the outdoor traveling area of the mobile object, and
the class is a class set for each object.

(5) The mobile object control information generation method according to any one of (1) to (4), wherein the class attributes recorded in the mobile object control information are
feature information about the class analyzed on the basis of detection information of a sensor mounted on the mobile object.

(6) The mobile object control information generation method according to any one of (1) to (5), wherein the class attributes recorded in the mobile object control information are
mobile object control information corresponding to the class input by a user.

(7) The mobile object control information generation method according to any one of (1) to (6), wherein the class attributes recorded in the mobile object control information are time-corresponding class attributes, and
the mobile object control information is configured such that
the time-corresponding class attributes corresponding to the traveling time of the
mobile object is selected and used when mobile object control is performed using the mobile object control information.

(8) The mobile object control information generation method according to any one of (1) to (7), wherein the class is a class set for each room present in the indoor traveling area of the mobile object, and
the class attributes recorded in the mobile object control information are information indicating the presence or absence of a person in each room.

(9) The mobile object control information generation method according to any one of (1) to (8), wherein the class is a class set for each room present in the indoor traveling area of the mobile object, and
the class attributes recorded in the mobile object control information are information indicating whether the mobile object is allowed to enter each room.

(10) The mobile object control information generation method according to any one of (1) to (9), wherein the class is a class set for an object present in the outdoor traveling area of the mobile object, and
the class attributes recorded in the mobile object control information are information indicating whether each object is accessible to the mobile object.

(11) The mobile object control information generation method according to any one of (1) to (10), the method further including:
displaying the map on a display unit by the data processing unit, and
generating mobile object control information in which feature information about classes or mobile object control information about classes is recorded as class attributes, in response to a user operation on the map displayed on the display unit.

(12) The mobile object control information generation method according to any one of (1) to (11),
the method further including: designating, by a task designation unit, a task to be executed by the mobile object and
performing processing for transmitting, to the mobile object, an execution command of the designated task and mobile object control information in which the class attributes are recorded.

(13) A mobile object control information generation device including a mobile object control information generation unit that generates mobile object control information in which feature information about a class or mobile object control information about the class is recorded as class attributes in association with the classes serving as segmented areas in the map of the traveling area of a mobile object.

(14) A mobile object control information generation device including: a display unit that displays the map of a traveling area of a mobile object;
an input unit that inputs feature information about a class or mobile object control information about classes serving as segmented areas in the map; and
a mobile object control information generation unit that generates or updates mobile object control information in which the feature information about a class input through the input unit or the mobile object control information about the class is recorded as class attributes.

(15) A mobile object that moves according to mobile object control information in which feature information about a class or mobile object control information about a class is recorded as class attributes in association with a class serving as segmented areas in the map of the traveling area of the mobile object.

(16) A mobile object control system including: a mobile object, a controller that transmits control information to the mobile object, and a map generation device that generates a map of the traveling area of the mobile object,
wherein the map generation device
generates mobile object control information in which feature information about a class or mobile object control information about a class is recorded as class attributes in association with the class serving as segmented areas in the map of the traveling area of a mobile object, and
wherein the controller
generates an updated map by performing processing for adding class attributes based on a user input to the mobile object control information generated by the map generation device, and performs travel control on the mobile object by using the generated updated map.

(17) A mobile object control system including: a mobile object, and a controller that transmits control information to the mobile object,
wherein the controller
generates a map of the traveling area of the mobile object, generates mobile object control information in which feature information about a class or mobile object control information about classes is recorded as class attributes in association with the classes serving as segmented areas in the generated map, and performs travel control on the mobile object by using the generated mobile object control information.

The series of processing described in this specification can be executed by hardware, software, or a composite configuration of both. If the series of processing is to be executed by software, the series of processing can be executed by installing a program recording the processing sequence into a memory in a computer embedded in dedicated hardware, or by installing the program into a general-purpose computer capable of executing various kinds of processing. For example, the program can be pre-recorded on a recording medium. Rather than being installed into a computer from a recording medium, the program can be received via a network such as a LAN (Local Area Network) or the Internet, and installed into a built-in recording medium such as a hard disk.

Additionally, various types of processing described in the description may be not only chronologically executed according to description but also executed in parallel or individually according to processing capability of a device that executes the processing or as necessary. In the present specification, the system is a logical set of configurations of a plurality of devices, and the devices having the configurations are not always located in the same housing.

### INDUSTRIAL APPLICABILITY

As described above, the configuration of one example according to the present disclosure implements, for example, a configuration for controlling a mobile object such as a robot by using data including a map in which class attributes for classes corresponding to rooms are recorded.

Specifically, for example, feature information about a class or mobile object control information about classes is recorded as class attributes in association with classes serving as segmented areas in a map of the traveling area of a mobile object such as a robot, for example, a semantic map. The map is a map that allows identification of a room type and the border between rooms, and the presence or absence of a person in a room or information indicating whether the entry of the robot is allowed is recorded as class attributes for the classes corresponding to the rooms. Travel control for a robot is performed using a map or data in which the class attributes are recorded.

The present configuration implements, for example, a configuration for controlling a mobile object such as a robot by using data including a map in which class attributes for classes corresponding to rooms are recorded.

### REFERENCE SIGNS LIST

10 Robot
11 Sensor
12 Communication unit
13 Drive unit
14 Task execution unit
15 Storage unit
30 Controller
31 Display unit (monitor)
32 Semantic map updating unit
33 Task designation unit
34 Input unit
35 Communication unit
36 Storage unit
50 Semantic map generation device
51 Map generation unit
52 Sensor information acquisition unit
53 Storage unit
54 Learning data generation unit
55 Semantic map generation unit
56 Sensor information processing unit
57 Communication unit
70 Artificial satellite
101 CPU
102 ROM
103 RAM
104 Bus
105 Input/output interface
106 Input unit
107 Output unit
108 Storage unit
109 Communication unit
110 Drive
111 Removable medium

1. A mobile object control information generation method executed in a mobile object control information generation device,
the method comprising:
generating, by a data processing unit, mobile object control information in which feature information about classes or mobile object control information about the class is recorded as class attributes in association with the class serving as segmented areas in a map of a traveling area of a mobile object.

2. The mobile object control information generation method according to claim 1, wherein the map is a semantic map generated by semantic mapping.

3. The mobile object control information generation method according to claim 1, wherein the map is a map that allows identification of a room type in an indoor traveling area of the mobile object and a border between rooms, and
the class is a class set for each room.

4. The mobile object control information generation method according to claim 1, wherein the map is a map that allows identification of an object in an outdoor traveling area of the mobile object, and
the class is a class set for each object.

5. The mobile object control information generation method according to claim 1, wherein the class attributes recorded in the mobile object control information are feature information about the class analyzed on the basis of detection information of a sensor mounted on the mobile object.

6. The mobile object control information generation method according to claim 1, wherein the class attributes recorded in the mobile object control information are mobile object control information corresponding to the class input by a user.

7. The mobile object control information generation method according to claim 1, wherein the class attributes recorded in the mobile object control information are time-corresponding class attributes, and
the mobile object control information is configured such that
the time-corresponding class attributes corresponding to a traveling time of the mobile object is selected and used when mobile object control is performed using the mobile object control information.

8. The mobile object control information generation method according to claim 1, wherein the class is a class set for each room present in an indoor traveling area of the mobile object, and
the class attributes recorded in the mobile object control information are information indicating presence or absence of a person in each room.

9. The mobile object control information generation method according to claim 1, wherein the class is a class set for each room present in an indoor traveling area of the mobile object, and
the class attributes recorded in the mobile object control information are information indicating whether the mobile object is allowed to enter each room.

10. The mobile object control information generation method according to claim 1, wherein the class is a class set for an object present in an outdoor traveling area of the mobile object, and
the class attributes recorded in the mobile object control information are information indicating whether each object is accessible to the mobile object.

11. The mobile object control information generation method according to claim 1, the method further comprising:
displaying the map on a display unit by the data processing unit, and
generating mobile object control information in which feature information about classes or mobile object control information about classes is recorded as class attributes, in response to a user operation on the map displayed on the display unit.

12. The mobile object control information generation method according to claim 1,
the method further comprising: designating, by a task designation unit, a task to be executed by the mobile object; and
performing processing for transmitting, to the mobile object, an execution command of the designated task and mobile object control information in which the class attributes are recorded.

13. A mobile object control information generation device comprising a mobile object control information generation unit that generates mobile object control information in which feature information about a class or mobile object control information about the class is recorded as class attributes in association with the class serving as segmented areas in a map of a traveling area of a mobile object.

14. A mobile object control information generation device comprising: a display unit that displays a map of a traveling area of a mobile object;
an input unit that inputs feature information about a class or mobile object control information about classes serving as segmented areas in the map; and
a mobile object control information generation unit that generates or updates mobile object control information in which the feature information about a class input through the input unit or the mobile object control information about the class is recorded as class attributes.

15. A mobile object that moves according to mobile object control information in which feature information about a class or mobile object control information about a class is recorded as class attributes in association with the class serving as segmented areas in a map of a traveling area of the mobile object.

16. A mobile object control system comprising: a mobile object, a controller that transmits control information to the mobile object, and a map generation device that generates a map of a traveling area of the mobile object,
wherein the map generation device
generates mobile object control information in which feature information about a class or mobile object control information about a class is recorded as class attributes in association with classes serving as segmented areas in the map of the traveling area of a mobile object, and
the controller
generates an updated map by performing processing for adding class attributes based on a user input to the mobile object control information generated by the map generation device, and
performs travel control on the mobile object by using the generated updated map.

17. A mobile object control system comprising: a mobile object, and a controller that transmits control information to the mobile object,
the controller
generates a map of a traveling area of the mobile object, generates mobile object control information in which feature information about a class or mobile object control information about a class is recorded as class attributes in association with the class serving as segmented area in the generated map, and performs travel control on the mobile object by using the generated mobile object control information.
